(19) United States
(12) Patent Application Publication
(10) Pub. No.: US 2026/0038486 A1
(43) Pub. Date: Feb. 5, 2026

(54) Wakewordless Voice Quickstarts

(71) Applicant: Sonos, Inc., Goleta, CA (US)

(72) Inventors: Alice Coucke, Paris (FR); Theodore Bluche, Paris (FR); Julien Balian, Paris (FR); Raffaele Tavarone, Paris (FR)

(21) Appl. No.: 19/296,746

(22) Filed: Aug. 11, 2025

Related U.S. Application Data
(63) Continuation of application No. 17/340,590, filed on Jun. 7, 2021, now Pat. No. 12,387,716.
(60) Provisional application No. 63/036,189, filed on Jun. 8, 2020.

(51) Int. Cl. G10L 15/16; G10L 15/06; G10L 15/08; G10L 15/22

(52) U.S. Cl. CPC G10L 15/16; G10L 15/063; G10L 15/22; G10L 2015/088; G10L 2015/223

(57) ABSTRACT

As noted above, example techniques relate to local voice control. A device may monitoring an input sound-data stream representing sound detected by the one or more microphones for keywords and generate a first keyword detection event corresponding to a voice input when one or more keyword engines detect sound data matching at least one first keyword of the one or more keywords. The device determines whether the second voice input matches a particular predetermined speaker profile of one or more predetermined speaker profiles. Based on (i) generating the first keyword detection event and (ii) determining that the second voice input includes sound data matching the particular predetermined speaker profile, the device performs a particular playback command associated with the at least one first keyword.

### CROSS-REFERENCE TO RELATED APPLICATIONS

This application is a continuation of U.S. patent application Ser. No. 17/340,590, filed Jun. 7, 2021, which claims priority to U.S. Patent Application Ser. No. 63/036,189, filed on Jun. 8, 2020, the disclosure of which is incorporated by reference herein in its entirety.

### FIELD OF THE DISCLOSURE

The present technology relates to consumer goods and, more particularly, to methods, systems, products, features, services, and other elements directed to voice-assisted control of media playback systems or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings where:

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 2A is a functional block diagram of an example playback device.

FIG. 2B is an isometric diagram of an example housing of the playback device of FIG. 2A.

FIG. 2C is a diagram of an example voice input.

FIG. 2D is a graph depicting an example sound specimen in accordance with aspects of the disclosure.

FIGS. 3A, 3B, 3C, 3D and 3E are diagrams showing example playback device configurations in accordance with aspects of the disclosure.

FIG. 4 is a functional block diagram of an example controller device in accordance with aspects of the disclosure.

FIGS. 5A and 5B are controller interfaces in accordance with aspects of the disclosure.

FIG. 6 is a message flow diagram of a media playback system.

FIG. 7A is a functional block diagram of an example network microphone device.

FIG. 7B is an isometric diagram of the example network microphone device.

FIG. 7C is a functional block diagram of certain components of the example network microphone device in accordance with aspects of the disclosure.

FIG. 7D is a functional block diagram of a neural architecture of the example network microphone device in accordance with aspects of the disclosure.

FIGS. 8A, 8B, 8C, and 8D illustrate example voice input processing sequences.

FIG. 9 is a schematic diagram illustrating the example network microphone device while paired with an example network device.

FIGS. 10A and 10B are controller interfaces in accordance with aspects of the disclosure.

FIG. 11 is a schematic diagram illustrating an example media playback system and cloud network in accordance with aspects of the disclosure.

FIG. 12 is a flow diagram of an example method to perform local voice control in accordance with aspects of the disclosure.

FIG. 13 is a flow diagram of an example method to perform local voice control in accordance with aspects of the disclosure.

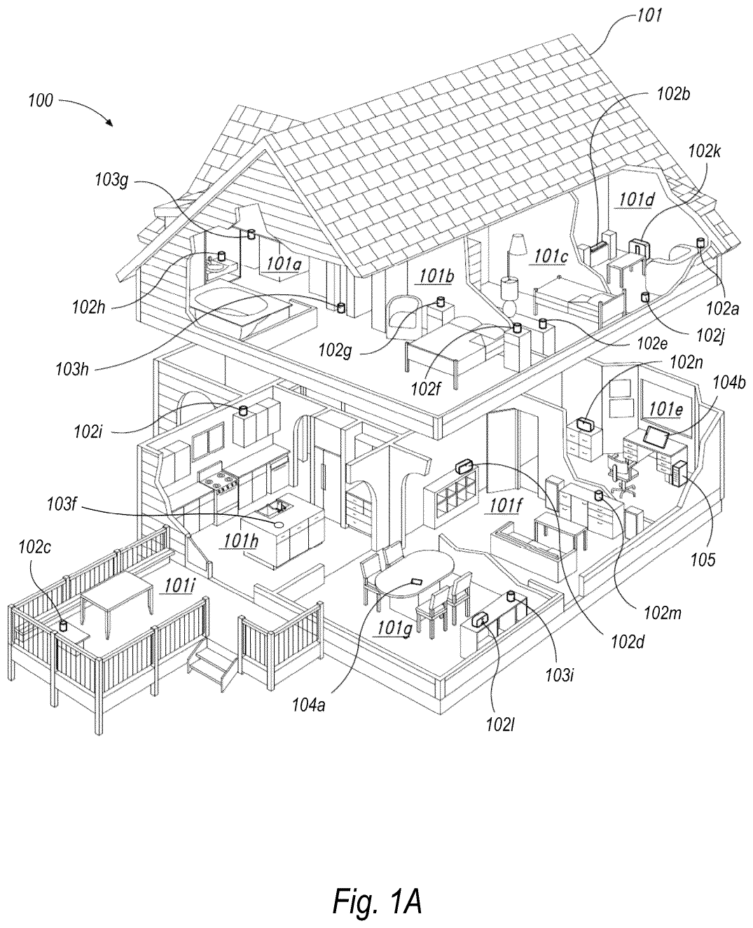

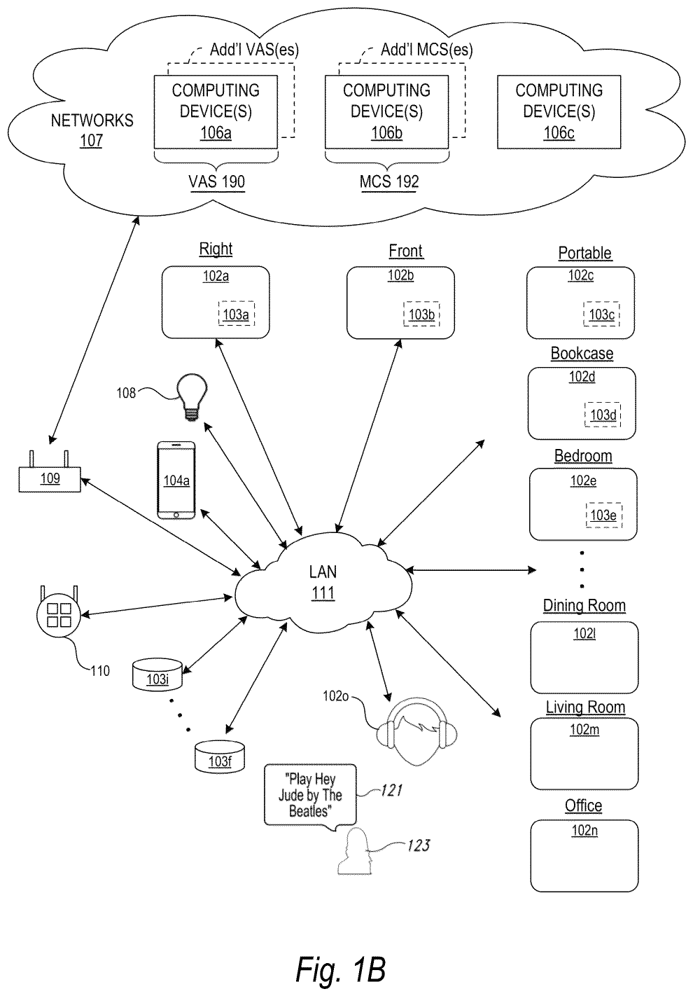

The drawings are for purposes of illustrating example embodiments, but it should be understood that the inventions are not limited to the arrangements and instrumentality shown in the drawings. In the drawings, identical reference numbers identify at least generally similar elements. To facilitate the discussion of any particular element, the most significant digit or digits of any reference number refers to the Figure in which that element is first introduced. For example, clement 103a is first introduced and discussed with reference to FIG. 1A.

### DETAILED DESCRIPTION

### I. Overview

Examples described herein relate to local voice control techniques using a networked microphone device (“NMD”). A NMD is a networked computing device that typically includes an arrangement of microphones, such as a microphone array, that is configured to detect sound present in the NMD's environment. NMDs may facilitate voice control of smart home devices, such as wireless audio playback devices, illumination devices, appliances, and home-automation devices (e.g., thermostats, door locks, etc.). NMDs may also be used to query a cloud-based voice assistant service (VAS) for information such as search queries, news, weather, and the like.

In one aspect, a NMD may implement a small-footprint (“mini”) spoken language understanding (SLU) pipeline. The mini-SLU pipeline derives intent of voice inputs by keyword spotting in natural language voice inputs. That is, the mini-SLU pipeline is configured to spot certain keywords, which correspond to respective commands. By spotting a particular keyword in a voice input, the mini-SLU pipeline directly derives an intent to perform the command associated with the spotted keyword. Further, in contrast to other keyword spotting approaches, the mini-SLU pipeline does not implement full automatic speech recognition (ASR). Instead, the mini-SLU directly performs detection of keywords from intermediate representations of the voice input and keywords using a keyword spotting neural network.

More particularly, an example mini-SLU pipeline may implement a neural architecture with three components: an acoustic encoder, a convolutional keyword detector network, and an auxiliary keyword encoder network, which may be referred to together as a hybrid keyword detector. The acoustic encoder is composed of a stack of recurrent neural layers and is pre-trained to generate quantized intermediate features from conditioned data representing a natural language voice input. The intermediate features are input to the convolutional keyword detector network trained to output keyword confidences. To support custom keywords (“an open-vocabulary model”), the weights of the convolutional keyword detector network are not necessarily trained directly, but are instead predicted by the auxiliary keyword encoder network. The keyword encoder network is itself a neural network applied to a phone sequence of a keyword to predict the parameters of the convolutional keyword detector network that would detect the keyword.

In an effort to maintain a small footprint, the mini-SLU pipeline is trained to detect a relatively small set of keywords compared with a cloud-based VAS. In some implementations, this set of keywords may be task-based. For instance, a mini-SLU pipeline implemented in a playback device may be trained to detect keywords corresponding to playback commands such as “play,” “pause,” or “skip.” As another example, a mini-SLU pipeline implemented in a washing machine may be trained to detect keywords such as “Start gentle cycle.”

In exemplary NMDs, the mini-SLU pipeline is implemented in parallel with cloud-based processing of natural language voice inputs. Cloud-based processing may be significantly more capable than processing using the mini-SLU pipeline. For instance, the mini-SLU may be capable of recognizing 1,000 or fewer keywords (words and phrases) while a cloud-based VAS is capable of recognizing a wide variety of words and phrases. Such numbers are merely representative and will vary based on the specific implementations.

Additionally or alternatively, the mini-SLU pipeline is implemented in parallel with a local voice input engine. In contrast with the mini-SLU, the local voice input engine implements full ASR to convert sound data from the microphones to text and then performs spoken language understanding to combine command keywords with parameter keywords. ASR-based local processing may be relatively more capable than the mini-SLU pipeline (and likewise have a larger footprint than the mini-SLU pipeline). For instance, an ASR-based local voice input processing may be capable of recognizing 10,000 keywords (words or phrases) compared with 1,000 or fewer for a mini-SLU pipeline.

On the other hand, processing voice inputs via the mini-SLU pipeline may be relatively faster than other types of local and/or cloud processing. In particular, the mini-SLU pipeline may be relatively quicker due to various factors such as scope (i.e., attempting to detect a relatively small set of keywords), design (e.g., directly spotting keywords without first performing ASR), and architecture (e.g., no latency as inherent in cloud-based processing). Due to this relative speed in processing voice inputs, voice inputs processed via the mini-SLU pipeline may be referred to herein as “quickstarts.”

To avoid duplicate processing of a voice input by the parallel voice processing pipelines, the mini-SLU pipeline may instruct or otherwise cause the other voice processing pipelines to forego or stop processing of a voice input when the mini-SLU pipeline successfully processes the voice input. On the other hand, if the mini-SLU pipeline is unable to process a voice input, that voice input may be processed by the ASR-based local voice input pipeline or the cloud-based VAS. At the same time, a user may request processing using a cloud-based VAS by pre-facing their voice input with a specific nonce wake word for that VAS. For example, a user might speak the wake word “Alexa” to invoke the AMAZON® VAS, “Ok, Google” to invoke the GOOGLE® VAS, “Hey, Siri” to invoke the APPLE® VAS, or “Hey, Sonos” to invoke a VAS offered by SONOS®, among other examples.

To identify whether sound detected by the NMD contains a voice input that includes a particular wake word, NMDs often utilize a wake-word engine, which is typically onboard the NMD. The wake-word engine may be configured to identify (i.e., “spot” or “detect”) a particular wake word in recorded audio using one or more identification algorithms, which may include pattern recognition trained to detect the frequency and/or time domain patterns that speaking the wake word creates. In practice, a wake word is typically a pre-determined nonce word or phrase used to “wake up” an NMD and cause it to invoke a particular voice assistant service (“VAS”) to interpret the intent of voice input in detected sound. Under this paradigm, when performing cloud-based voice processing, the NMD only needs to be able to detect a wake-word in a voice input—the heavy-lifting of voice processing (i.e., spoken language understanding) is offloaded to the cloud.

When a wake-word engine detects a wake word in recorded audio, the NMD may determine that a wake-word event (i.e., a “wake-word trigger”) has occurred, which indicates that the NMD has detected sound that includes a potential voice input. The occurrence of the wake-word event typically causes the NMD to perform additional processes involving the detected sound. With a VAS wake-word engine, these additional processes may include extracting detected-sound data from a buffer, among other possible additional processes, such as outputting an alert (e.g., an audible chime and/or a light indicator) indicating that a wake word has been identified. Extracting the detected sound may include reading out and packaging a stream of the detected-sound according to a particular format and transmitting the packaged sound-data to an appropriate VAS for interpretation.

In turn, the VAS corresponding to the wake word that was identified by the wake-word engine receives the transmitted sound data from the NMD over a communication network. A VAS traditionally takes the form of a remote service implemented using one or more cloud servers configured to process voice inputs (e.g., AMAZON's ALEXA, APPLE's SIRI, MICROSOFT's CORTANA, GOOGLE'S ASSISTANT, etc.). In some instances, certain components and functionality of the VAS may be distributed across local and remote devices.

When a VAS receives detected-sound data, the VAS processes this data, which involves identifying the voice input and determining intent of words captured in the voice input. The VAS may then provide a response back to the NMD with some instruction according to the determined intent. Based on that instruction, the NMD may cause one or more smart devices to perform an action. For example, in accordance with an instruction from a VAS, an NMD may cause a playback device to play a particular song or an illumination device to turn on/off, among other examples.

In contrast to a VAS wake-word engine, the mini SLU might not trigger based on nonce wake words and instead operate in a wakewordless paradigm. That is, the mini-SLU pipeline continually monitors data from the microphones for the keywords that it is trained to detect. Under this paradigm, a user may more quickly and naturally interact with the NMD without needing to preface their request with a nonce wake word. In this design, concern that NMDs are continually listening for these keywords is mitigated by the fact that the user's voice recordings are temporary and remain local to the user's device.

One challenge with traditional wake-word engines is that they can be prone to false positives caused by “false wake word” triggers. A false positive in the NMD context generally refers to detected sound input that erroneously invokes a VAS. With a VAS wake-work engine, a false positive may invoke the VAS, even though there is no user actually intending to speak a wake word to the NMD.

For example, a false positive can occur when a wake-word engine identifies a wake word in detected sound from audio (e.g., music, a podcast, TV, etc.) playing in the environment of the NMD. This output audio may be playing from a playback device in the vicinity of the NMD or by the NMD itself. For instance, when the audio of a commercial advertising AMAZON's ALEXA service is output in the vicinity of the NMD, the word “Alexa” in the commercial may trigger a false positive. A word or phrase in output audio that causes a false positive may be referred to herein as a “false wake word.”

In other examples, words that are phonetically similar to an actual wake word cause false positives. For example, when the audio of a commercial advertising LEXUS® automobiles is output in the vicinity of the NMD, the word “Lexus” may be a false wake word that causes a false positive because this word is phonetically similar to “Alexa.” As other examples, false positives may occur when a person speaks a VAS wake word or phonetically similar word in conversation.

The occurrences of false positives are undesirable, as they may cause the NMD to consume additional resources or interrupt audio playback, among other possible negative consequences. Some NMDs may avoid false positives by requiring a button press to invoke the VAS, such as on the AMAZON FIRETV remote or the APPLE TV remote. In practice, the impact of a false positive generated by a VAS wake-word engine is often partially mitigated by the VAS processing the detected-sound data and determining that the detected-sound data does not include a recognizable voice input.

A mini-SLU pipeline may be relatively more prone to false positive detections as compared with a VAS wake word engine. The mini-SLU pipeline is triggered based on a wider variety of words, including words that may be more commonly used in conversation (e.g., “play” “on”, etc.) as compared with nonce wake words of a cloud-based VAS, which creates more opportunities for false positives. Second, unlike VAS wake word engines which can be trained on large sets of training data since the nonce wake words are known in advance, for at least some keywords (e.g., custom keywords), the keyword detector network is not trained directly, but instead relies on weights predicted by the keyword encoder network, which inherently produces less robust keyword detection.

To mitigate this propensity for false positives, after generating a keyword detection event when a given keyword is detected by a mini-SLU pipeline, an example NMD may require satisfaction of one or more conditions before performing a command associated with the detected keyword. In particular, these conditions may correspond with conditions that indicate likelihood that a detected keyword was intended by a user as a voice input. Accordingly, when these conditions are satisfied, the likelihood that the detected keyword is not a false positive is increased. Conversely, when these conditions are not satisfied, it is more likely that the detected keyword is a false positive.

In particular, one condition that may apply generally is whether the voice input matches a speaker profile corresponding to a particular user. Example NMDs may maintain or have access to pre-determined speaker profiles corresponding to the users in a household. When a voice input matches one of these pre-determined speaker profiles, confidence that the utterance was intended as a voice input to the NMD is increased.

For example, a particular user may set up a custom keyword such as “Party Time” to trigger a particular command or action (such as playback of a particular playlist across multiple (or all) playback devices in a household, as may be useful during a party). When the user utters the keyword “Party Time,” the detecting NMD may recognize that the utterance includes that keyword and further determine that the speaker of the utterance is the particular user. Since the speaker of the custom keyword is the particular user who configured the keyword, the NMD can be more confident that the speaker intended that utterance as a voice input than the NMD would otherwise be without this determination.

Example local voice input processing pipelines such as the mini-SLU and the ASR-based local voice input pipeline, may support custom keywords. Relative to pre-loaded keywords, custom keywords may be relatively more difficult to spot, as the neural network(s) for keyword spotting in such pipelines may have been trained with relatively more training data for the pre-loaded keywords. Custom keywords might not have any particular training data at all; instead, the neural network weights used to detect custom keywords may be predicted by a keyword encoder.

Some example voice inputs may include both pre-loaded and custom keywords. For instance, when analyzing a voice input (e.g., “play the party time playlist”), the NMD may have relatively higher confidence in detecting a pre-loaded keyword (e.g., “play”) and relatively lower confidence in detecting a custom keyword (e.g., “party time playlist”). In some examples, the NMD may assign a confidence value to the voice input as a whole based on the individual probabilities of detecting the constituent keywords.

Example local voice input processing pipelines such as the mini-SLU pipeline and the ASR-based local voice input pipeline may derive a greater confidence level in custom keywords based on detecting such keywords in a voice input with pre-loaded keywords. That is, when a pre-loaded keyword is detected in a voice input with relatively high confidence and a custom keyword is also detected in the voice input albeit with relatively low confidence, the NMD may assign a higher confidence to the voice input as a whole than would otherwise be assigned to a voice input with the constituent keywords. This functionality is based on this assumption that when the NMD has detected one or more keywords with high confidence, other sounds in time proximity to those high-confidence keywords are more likely to be keywords as well.

As noted above, example techniques relate to wakewordless local voice control. An example implementation involves a network microphone device (NMD) including one or more microphones, a network interface, one or more processors, at least one speaker, one or more processor and data storage having stored therein instructions executable by the one or more processors. The NMD monitors, via one or more keyword engines, an input sound-data stream representing sound detected by the one or more microphones for (i) a wake word associated with a voice assistant service and (ii) one or more keywords. The one or more keywords are different than the wake word. The NMD generates a first wake-word detection event corresponding to a first voice input when the one or more keyword engines detect sound data matching the wake word in the input sound-data stream. Based on generating the first wake-word detection event, the NMD causes the voice assistant service to process the first voice input. The NMD generates a first keyword detection event corresponding to a second voice input when the one or more keyword engines detect sound data matching at least one first keyword of the one or more keywords. The NMD determines that the second voice input matches a particular predetermined speaker profile of one or more predetermined speaker profiles and based on (i) generating the first keyword detection event and (ii) determining that the second voice input includes sound data matching the particular predetermined speaker profile, performs a particular playback command associated with the at least one first keyword.

Another example implementation involves a network microphone device (NMD) including one or more microphones, a network interface, one or more processors, at least one speaker, one or more processor and data storage having stored therein instructions executable by the one or more processors. The NMD monitors, via one or more keyword engines, an input sound-data stream representing sound detected by the one or more microphones for one or more keywords from a keyword library. The keyword library includes pre-defined keywords and user-defined keywords. The NMD generates a first keyword detection event corresponding to a first voice input when the one or more keyword engines detect sound data matching a first keyword from the keyword library in the input sound-data stream. The NMD performs automatic speech recognition on the first voice input to detect keywords from the keyword library in the first voice input. Performing automatic speech recognition on the first voice input includes detecting one or more pre-defined keywords from the keyword library in the first voice input, detecting a first user-defined keyword in the first voice input, and determining a confidence metric indicating confidence in recognizing keywords from the keyword library in the first voice input. Based on detecting the one or more pre-defined keywords in combination with the first user-defined keyword, the NMD modifies the confidence metric to indicate increased confidence in detecting keywords from the keyword library in the first voice input.

While some embodiments described herein may refer to functions performed by given actors, such as “users” and/or other entities, it should be understood that this description is for purposes of explanation only. The claims should not be interpreted to require action by any such example actor unless explicitly required by the language of the claims themselves.

Moreover, some functions are described herein as being performed “based on” or “in response to” another element or function. “Based on” should be understood that one element or function is related to another function or element. “In response to” should be understood that one clement or function is a necessary result of another function or element. For the sake of brevity, functions are generally described as being based on another function when a functional link exists; however, such disclosure should be understood as disclosing either type of functional relationship.

### II. Example Operation Environment

FIGS. 1A and 1B illustrate an example configuration of a media playback system 100 (or “MPS 100”) in which one or more embodiments disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b, (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102o), network microphone devices 103 (identified individually as “NMDs” 103a-102i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A). In embodiments described below, one or more of the various playback devices 102 may be configured as portable playback devices, while others may be configured as stationary playback devices. For example, the headphones 102o (FIG. 1B) are a portable playback device, while the playback device 102d on the bookcase may be a stationary device. As another example, the playback device 102c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices 102, 103, and 104 and/or other network devices of the MPS 100 may be coupled to one another via point-to-point connections and/or over other connections, which may be wired and/or wireless, via a network 111, such as a LAN including a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related embodiment, the Left playback device 102j may communicate with other network devices, such as the playback device 102b, which may be designated as the “Front” device, via a point-to-point connection and/or other connections via the NETWORK 111.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the home environment 101.

In some implementations, the various playback devices, NMDs, and/or controller devices 102-104 may be communicatively coupled to at least one remote computing device associated with a VAS and at least one remote computing device associated with a media content service (“MCS”). For instance, in the illustrated example of FIG. 1B, remote computing devices 106 are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 102 may take the form of or include an on-board (e.g., integrated) network microphone device. For example, the playback devices 102a-e include or are otherwise equipped with corresponding NMDs 103a-c, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 102d because it is physically situated on a bookcase. Similarly, the NMD 103f may be assigned the named “Island” because it is physically situated on an island countertop in the Kitchen 101h (FIG. 1A). Some playback devices may be assigned names according to a zone or room, such as the playback devices 102e, 102l, 102m, and 102n, which are named “Bedroom,” “Dining Room,” “Living Room,” and “Office,” respectively. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the network 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. application Ser. No. 15/438,749 filed Feb. 21, 2017, and titled “Voice Control of a Media Playback System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. application Ser. No. 15/438,749.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 102l, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. patent application Ser. No. 15/438,749.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the NETWORK 111 (FIG. 1B) may be eliminated and the single playback device 102 and/or the single NMD 103 may communicate directly with the remote computing devices 106-d. In some embodiments, a telecommunication network (e.g., an LTE network, a 5G network, etc.) may communicate with the various playback, network microphone, and/or controller devices 102-104 independent of a LAN.

### a. Example Playback & Network Microphone Devices

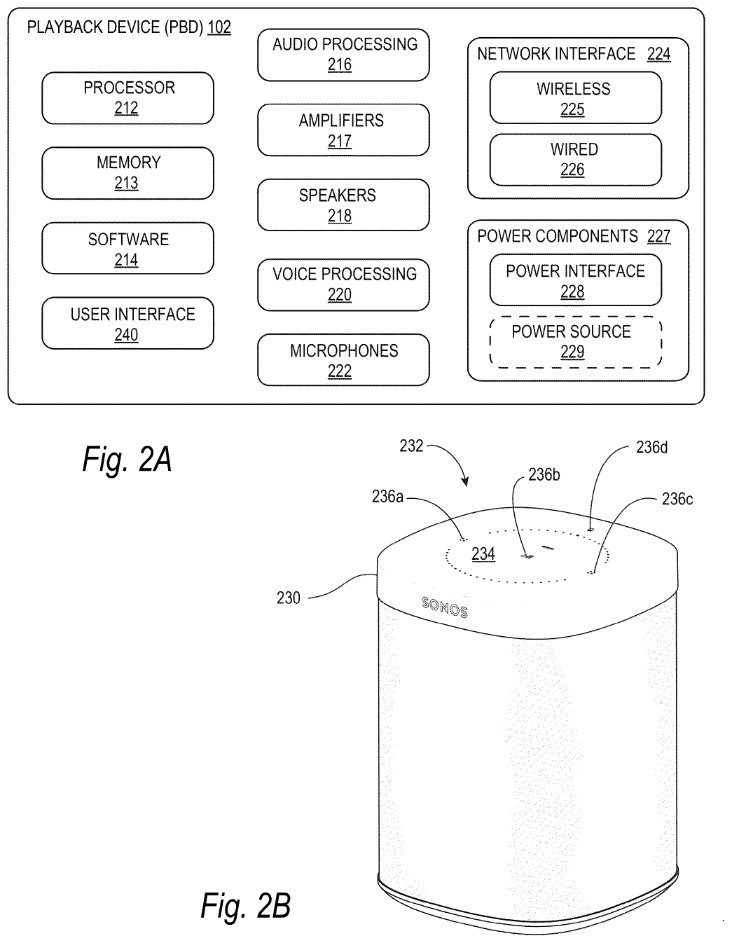

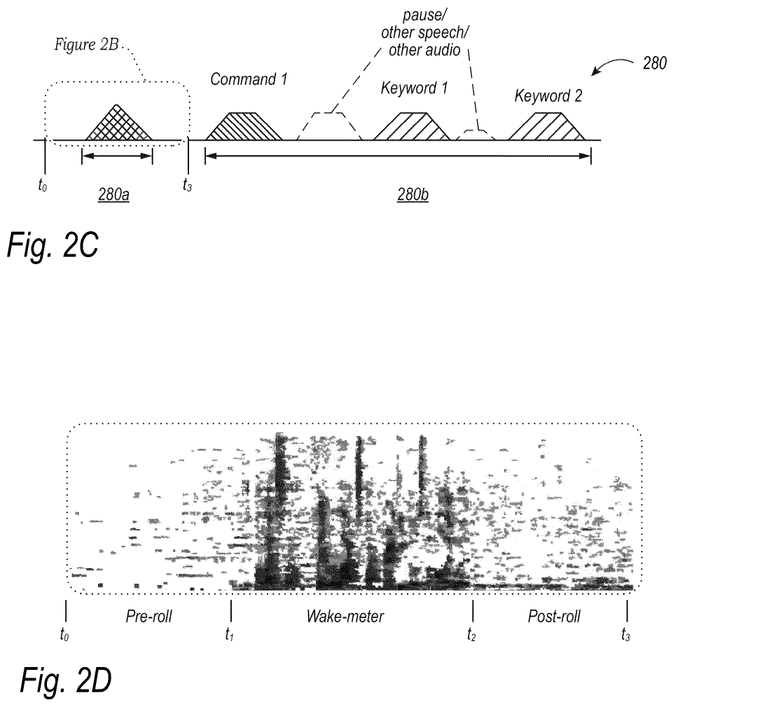

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a playback device may not include the speakers 218, but instead may include a speaker interface for connecting the playback device to external speakers. In certain embodiments, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the playback device 102 to communicate over a wired connection with other devices in accordance with a communication protocol (e.g., IEEE 802.3). While the network interface 224 shown in FIG. 2A includes both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphone).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 further includes a user interface 240 that may facilitate user interactions independent of or in conjunction with user interactions facilitated by one or more of the controller devices 104. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the playback device 102. The microphones 222 may be arranged in various positions along and/or within the top portion 234 or other areas of the housing 230 so as to detect sound from one or more directions relative to the playback device 102.

By way of illustration, SONOS, Inc. presently offers (or has offered) for sale certain playback devices that may implement certain of the embodiments disclosed herein, including a “PLAY:1,” “PLAY:3,” “PLAY:5,” “PLAYBAR,” “CONNECT: AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIGS. 2A or 2B or to the SONOS product offerings. For example, a playback device may include, or otherwise take the form of, a wired or wireless headphone set, which may operate as a part of the MPS 100 via a network interface or the like. In another example, a playback device may include or interact with a docking station for personal mobile media playback devices. In yet another example, a playback device may be integral to another device or component such as a television, a lighting fixture, or some other device for indoor or outdoor use.

FIG. 2C is a diagram of an example voice input 280 that may be processed by an NMD or an NMD-equipped playback device. The voice input 280 may include a keyword portion 280a and an utterance portion 280b. The keyword portion 280a may include a wake word or a local keyword.

In the case of a wake word, the keyword portion 280a corresponds to detected sound that caused a VAS wake-word event. In practice, a wake word is typically a predetermined nonce word or phrase used to “wake up” an NMD and cause it to invoke a particular voice assistant service (“VAS”) to interpret the intent of voice input in detected sound. For example, a user might speak the wake word “Alexa” to invoke the AMAZON® VAS, “Ok, Google” to invoke the GOOGLE® VAS, or “Hey, Siri” to invoke the APPLE® VAS, among other examples. In practice, a wake word may also be referred to as, for example, an activation-, trigger-, wakeup-word or -phrase, and may take the form of any suitable word, combination of words (e.g., a particular phrase), and/or some other audio cue.

The utterance portion 280b corresponds to detected sound that potentially comprises a user request following the keyword portion 280a. An utterance portion 280b can be processed to identify the presence of any words in detected-sound data by the NMD in response to the event caused by the keyword portion 280a. In various implementations, an underlying intent can be determined based on the words in the utterance portion 280b. In certain implementations, an underlying intent can also be based or at least partially based on certain words in the keyword portion 280a, such as when keyword portion includes a command keyword. In any case, the words may correspond to one or more commands, as well as a certain command and certain keywords.

A keyword in the voice utterance portion 280b may be, for example, a word identifying a particular device or group in the MPS 100. For instance, in the illustrated example, the keywords in the voice utterance portion 280b may be one or more words identifying one or more zones in which the music is to be played, such as the Living Room and the Dining Room (FIG. 1A). In some cases, the utterance portion 280b may include additional information, such as detected pauses (e.g., periods of non-speech) between words spoken by a user, as shown in FIG. 2C. The pauses may demarcate the locations of separate commands, keywords, or other information spoke by the user within the utterance portion 280b.

Based on certain command criteria, the NMD and/or a remote VAS may take actions as a result of identifying one or more commands in the voice input. Command criteria may be based on the inclusion of certain keywords within the voice input, among other possibilities. Additionally, AMAstate and/or zone-state variables in conjunction with identification of one or more particular commands. Control-state variables may include, for example, indicators identifying a level of volume, a queue associated with one or more devices, and playback state, such as whether devices are playing a queue, paused, etc. Zone-state variables may include, for example, indicators identifying which, if any, zone players are grouped.

In some implementations, the MPS 100 is configured to temporarily reduce the volume of audio content that it is playing upon detecting a certain keyword, such as a wake word, in the keyword portion 280a. The MPS 100 may restore the volume after processing the voice input 280. Such a process can be referred to as ducking, examples of which are disclosed in U.S. patent application Ser. No. 15/438,749, incorporated by reference herein in its entirety.

FIG. 2D shows an example sound specimen. In this example, the sound specimen corresponds to the sound-data stream (e.g., one or more audio frames) associated with a spotted wake word or command keyword in the keyword portion 280a of FIG. 2A. As illustrated, the example sound specimen comprises sound detected in an NMD's environment (i) immediately before a wake or command word was spoken, which may be referred to as a pre-roll portion (between times to and t₁), (ii) while a wake or command word was spoken, which may be referred to as a wake-meter portion (between times t₁ and t₂), and/or (iii) after the wake or command word was spoken, which may be referred to as a post-roll portion (between times t₂ and t₃). Other sound specimens are also possible. In various implementations, aspects of the sound specimen can be evaluated according to an acoustic model which aims to map mels/spectral features to phonemes in a given language model for further processing. For example, automatic speech recognition (ASR) may include such mapping for command-keyword detection. Wake-word detection engines, by contrast, may be precisely tuned to identify a specific wake-word, and a downstream action of invoking a VAS (e.g., by targeting only nonce words in the voice input processed by the playback device).

ASR for local keyword detection may be tuned to accommodate a wide range of keywords (e.g., 5, 10, 100, 1,000, 10,000 keywords). Local keyword detection, in contrast to wake-word detection, may involve feeding ASR output to an onboard, local NLU which together with the ASR determine when local keyword events have occurred. In some implementations described below, the local NLU may determine an intent based on one or more keywords in the ASR output produced by a particular voice input. In these or other implementations, a playback device may act on a detected command keyword event only when the playback devices determine that certain conditions have been met, such as environmental conditions (e.g., low background noise).

### b. Example Playback Device Configurations

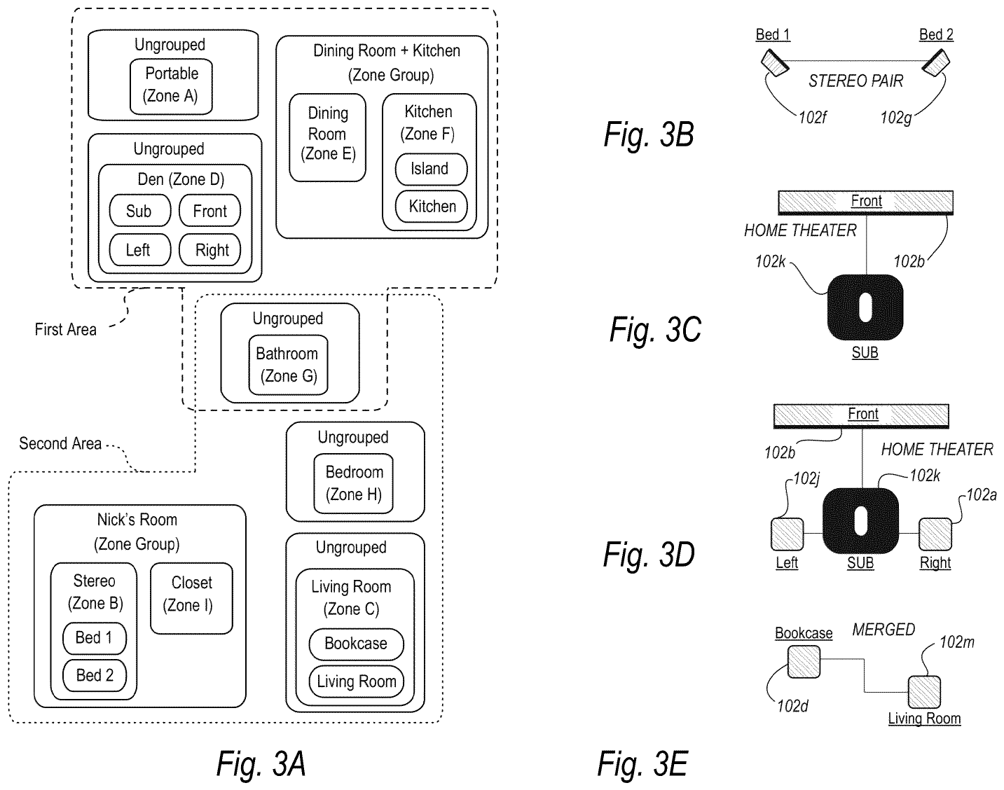

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various embodiments, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some embodiments, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101h (FIG. 1A) and the Bed 2 device may be the playback device 102g also in the master bedroom 101h (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one embodiment, the playback devices 102d and 102m may playback audio in synchrony, during which each outputs the full range of audio content that each respective playback device 102d and 102m is capable of rendering.

In some embodiments, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in previously referenced U.S. patent application Ser. No. 15/438,749. In some embodiments, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room +Kitchen,” as shown in FIG. 3A. In some embodiments, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the MPS 100, which may be shared from time to time among the devices so that one or more of the devices have the most recent data associated with the system.

In some embodiments, the memory 213 of the playback device 102 may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group.

Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second arca named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Arca may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. application Ser. No. 15/682,506 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In embodiments described below, the memory 213 is configured to store a set of command data for selecting a particular VAS when processing voice inputs. During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone.

For instance, the user may be in the Office zone where the playback device 102n is playing the same hip-hop music that is being played by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

### c. Example Controller Devices

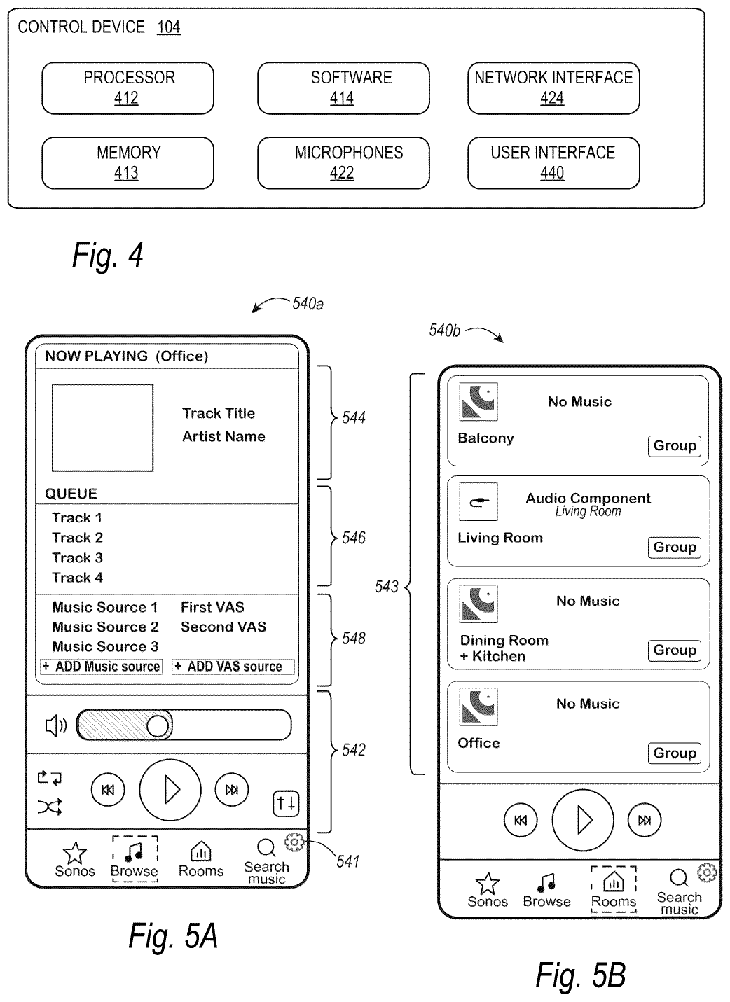

FIG. 4 is a functional block diagram illustrating certain aspects of a selected one of the controller devices 104 of the MPS 100 of FIG. 1A. Such controller devices may also be referred to herein as a “control device” or “controller.” The controller device shown in FIG. 4 may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others.

As shown in FIG. 4, the controller device 104 also includes a user interface 440 that is generally configured to facilitate user access and control of the MPS 100. The user interface 440 may include a touch-screen display or other physical interface configured to provide various graphical controller interfaces, such as the controller interfaces 540a and 540b shown in FIGS. 5A and 5B. Referring to FIGS. 5A and 5B together, the controller interfaces 540a and 540b includes a playback control region 542, a playback zone region 543, a playback status region 544, a playback queue region 546, and a sources region 548. The user interface as shown is just one example of an interface that may be provided on a network device, such as the controller device shown in FIG. 4, and accessed by users to control a media playback system, such as the MPS 100. Other user interfaces of varying formats, styles, and interactive sequences may alternatively be implemented on one or more network devices to provide comparable control access to a media playback system.

The playback control region 542 (FIG. 5A) may include selectable icons (e.g., by way of touch or by using a cursor) that, when selected, cause playback devices in a selected playback zone or zone group to play or pause, fast forward, rewind, skip to next, skip to previous, enter/exit shuffle mode, enter/exit repeat mode, enter/exit cross fade mode, etc. The playback control region 542 may also include selectable icons that, when selected, modify equalization settings and/or playback volume, among other possibilities.

The playback zone region 543 (FIG. 5B) may include representations of playback zones within the MPS 100. The playback zones regions 543 may also include a representation of zone groups, such as the Dining Room +Kitchen zone group, as shown.

In some embodiments, the graphical representations of playback zones may be selectable to bring up additional selectable icons to manage or configure the playback zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the playback zone region 543 (FIG. 5B) may be dynamically updated as playback zone or zone group configurations are modified.

The playback status region 544 (FIG. 5A) may include graphical representations of audio content that is presently being played, previously played, or scheduled to play next in the selected playback zone or zone group. The selected playback zone or zone group may be visually distinguished on a controller interface, such as within the playback zone region 543 and/or the playback status region 544. The graphical representations may include track title, artist name, album name, album year, track length, and/or other relevant information that may be useful for the user to know when controlling the MPS 100 via a controller interface.

The playback queue region 546 may include graphical representations of audio content in a playback queue associated with the selected playback zone or zone group. In some embodiments, each playback zone or zone group may be associated with a playback queue comprising information corresponding to zero or more audio items for playback by the playback zone or zone group. For instance, each audio item in the playback queue may comprise a uniform resource identifier (URI), a uniform resource locator (URL), or some other identifier that may be used by a playback device in the playback zone or zone group to find and/or retrieve the audio item from a local audio content source or a networked audio content source, which may then be played back by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streamed audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue or may be associated with a new playback queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the playback queue associated with the established zone group before the established zone group was ungrouped. Other examples are also possible.

With reference still to FIGS. 5A and 5B, the graphical representations of audio content in the playback queue region 646 (FIG. 5A) may include track titles, artist names, track lengths, and/or other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 548 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some embodiments, a user may assign a VAS exclusively to one or more NMDs. For example, a user may assign a first VAS to one or both of the NMDs 102a and 102b in the Living Room shown in FIG. 1A, and a second VAS to the NMD 103f in the Kitchen. Other examples are possible.

### d. Example Audio Content Sources

The audio sources in the sources region 548 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some embodiments audio content may be provided by one or more media content services.

Example audio content sources may include a memory of one or more playback devices in a media playback system such as the MPS 100 of FIG. 1, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

In some embodiments, audio content sources may be added or removed from a media playback system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media playback system and generating or updating an audio content database comprising metadata (e.g., title, artist, album, track length, among others) and other associated information, such as a URI or URL for each identifiable audio item found. Other examples for managing and maintaining audio content sources may also be possible.

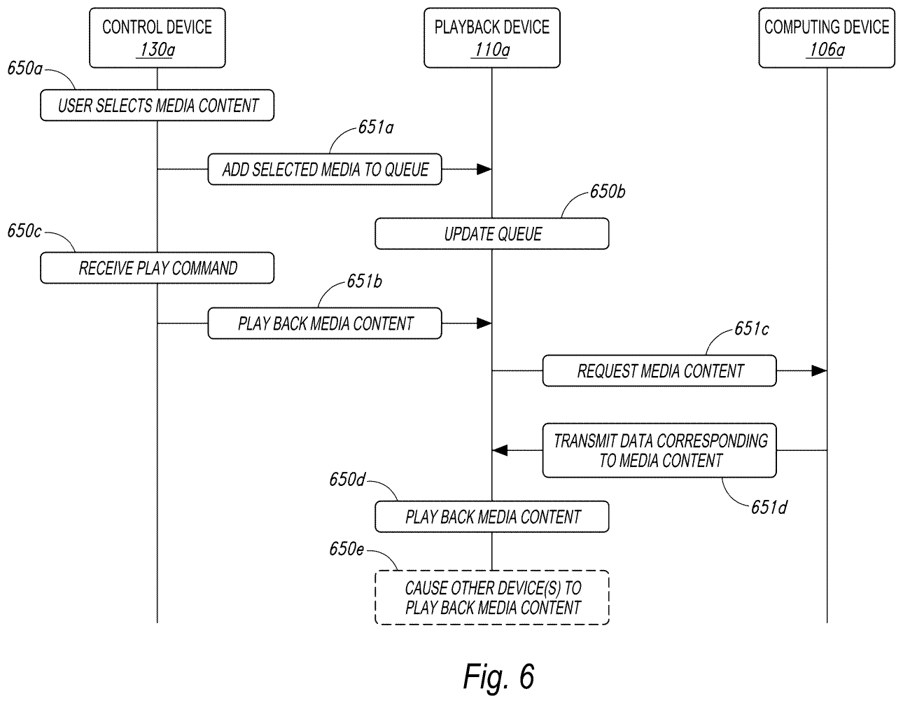

FIG. 6 is a message flow diagram illustrating data exchanges between devices of the MPS 100. At step 650a, the MPS 100 receives an indication of selected media content (e.g., one or more songs, albums, playlists, podcasts, videos, stations) via the control device 104. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 104 transmits a message 651a to the playback device 102 (FIGS. 1A-1C) to add the selected media content to a playback queue on the playback device 102.

At step 650b, the playback device 102 receives the message 651a and adds the selected media content to the playback queue for play back.

At step 650c, the control device 104 receives input corresponding to a command to play back the selected media content. In response to receiving the input corresponding to the command to play back the selected media content, the control device 104 transmits a message 65 1b to the playback device 102 causing the playback device 102 to play back the selected media content. In response to receiving the message 651b, the playback device 102 transmits a message 651c to the computing device 106 requesting the selected media content. The computing device 106, in response to receiving the message 651c, transmits a message 651d comprising data (e.g., audio data, video data, a URL, a URI) corresponding to the requested media content.

At step 650d, the playback device 102 receives the message 651d with the data corresponding to the requested media content and plays back the associated media content.

At step 650e, the playback device 102 optionally causes one or more other devices to play back the selected media content. In one example, the playback device 102 is one of a bonded zone of two or more players (FIG. 1M). The playback device 102 can receive the selected media content and transmit all or a portion of the media content to other devices in the bonded zone. In another example, the playback device 102 is a coordinator of a group and is configured to transmit and receive timing information from one or more other devices in the group. The other one or more devices in the group can receive the selected media content from the computing device 106, and begin playback of the selected media content in response to a message from the playback device 102 such that all of the devices in the group play back the selected media content in synchrony.

### III. Example Network Microphone Device

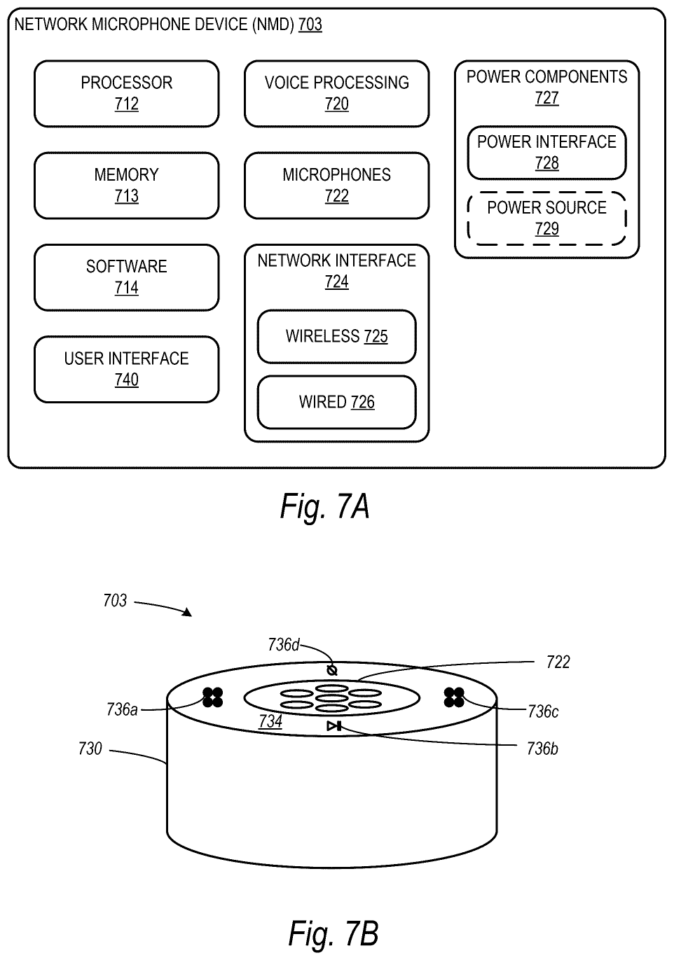

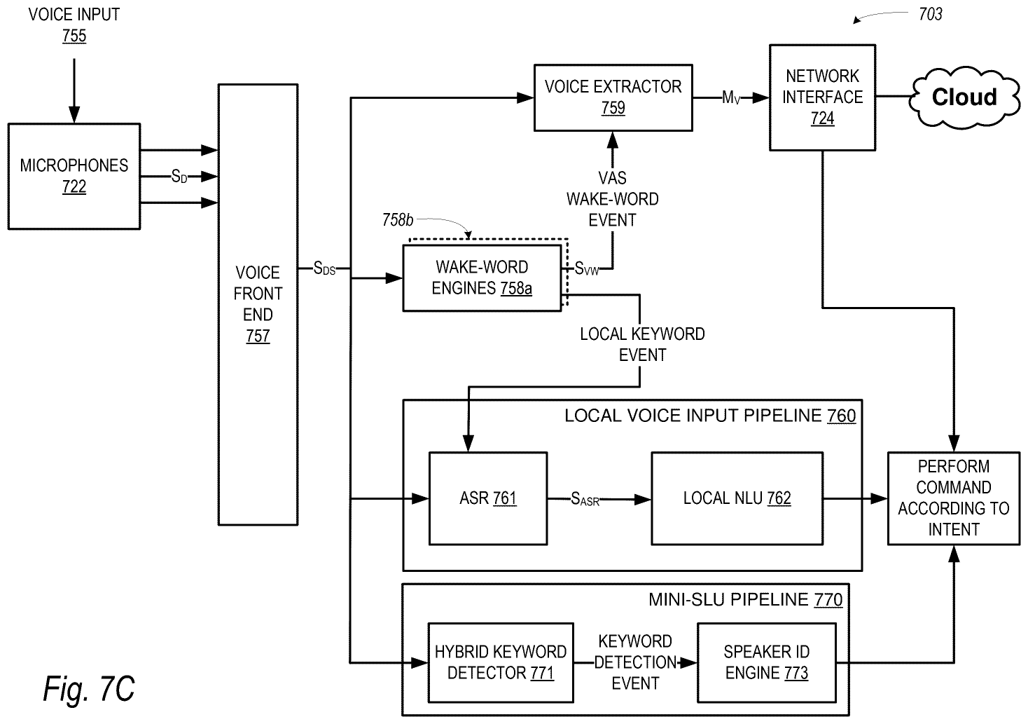

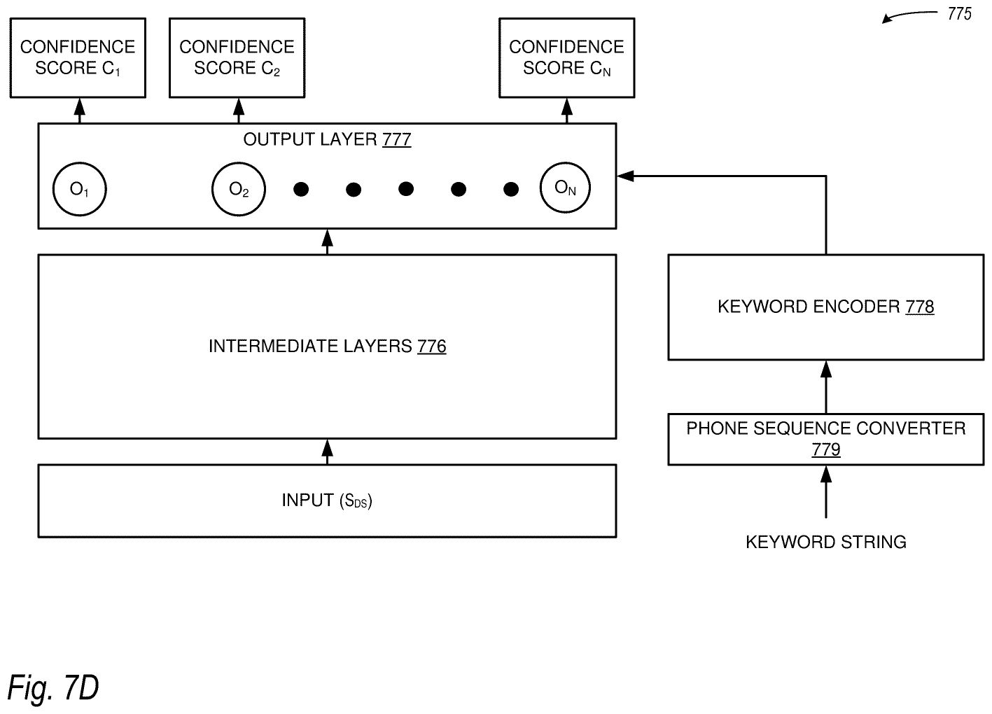

FIG. 7A is a functional block diagram illustrating certain aspects of an example network microphone device (NMD) 703. Generally, the NMD 703 may be similar to the network microphone device(s) 103 illustrated in FIGS. 1A and 1B. As shown, the NMD 703 includes various components, each of which is discussed in further detail below. The various components of the NMD 703 may be operably coupled to one another via a system bus, communication network, or some other connection mechanism.

Many of these components are similar to the playback device 102 of FIG. 2A. In some examples, the NMD 703 may be implemented in a playback device 102. In such cases, the NMD 703 might not include duplicate components (e.g., a network interface 224 and a network 724), but may instead share several components to carry out both playback and voice control functions. Alternatively, within some examples, the NMD 703 is not designed for audio content playback and therefore may exclude audio processing components 216, amplifiers 217, and/or speakers 218 or may include relatively less capable versions of these components (e.g., less powerful amplifier(s) 217 and/or smaller speakers 218). An example of such a device is the AMAZON ECHO DOT®.

As shown, the NMD 703 includes at least one processor 712, which may be a clock-driven computing component configured to process input data according to instructions stored in memory 713. The memory 713 may be a tangible, non-transitory, computer-readable medium configured to store instructions that are executable by the processor 712. For example, the memory 713 may be data storage that can be loaded with software code 714 that is executable by the processor 712 to achieve certain functions.

The at least one network interface 724 may take the form of one or more wireless interfaces 725 and/or one or more wired interfaces 726. The wireless interface 725 may provide network interface functions for the NMD 703 to wirelessly communicate with other devices (e.g., playback device(s) 102, other NMD(s) 103, and/or controller device(s) 104) in accordance with a communication protocol (e.g., any wireless standard including IEEE 802.11a, 802.11b, 802.11g, 802.11n, 802.11ac, 802.15, 4G mobile communication standard, and so on). The wired interface 726 may provide network interface functions for the NMD 703 to communicate over a wired connection with other devices in accordance with a communication protocol (e.g., IEEE 802.3). While the network interface 724 shown in FIG. 7A includes both wired and wireless interfaces, the playback device 102 may in various implementations include only wireless interface(s) or only wired interface(s).

As shown in FIG. 7A, the NMD 703 also includes voice processing components 720 that are operably coupled to microphones 722. The microphones 722 are configured to detect sound (i.e., acoustic waves) in the environment of the NMD 703, which is then provided to the voice processing components 720. More specifically, the microphones 722 are configured to detect sound and convert the sound into a digital or analog signal representative of the detected sound, which can then cause the voice processing component 720 to perform various functions based on the detected sound, as described in greater detail below. In one implementation, the microphones 722 are arranged as one or more arrays of microphones (e.g., an array of six microphones). In some implementations, the NMD 703 includes more than six microphones (e.g., eight microphones or twelve microphones) or fewer than six microphones (e.g., four microphones, two microphones, or a single microphone).

In operation, similar to the voice-processing components 220 of the NMD-equipped playback device 102 the voice-processing components 720 are generally configured to detect and process sound received via the microphones 722, identify potential voice input in the detected sound, and extract detected-sound data to enable processing of the voice input by a cloud-based VAS, such as the VAS 190 (FIG. 1B), or a local NLU. The voice processing components 720 may include one or more analog-to-digital converters, an acoustic echo canceller (“AEC”), a spatial processor, one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 720 may include or otherwise take the form of one or more DSPs or one or more modules of a DSP. In some implementations, one or more of the voice processing components 720 may be a subcomponent of the processor 712.

As further shown in FIG. 7A, the NMD 703 also includes power components 727. The power components 727 include at least an external power source interface 728, which may be coupled to a power source (not shown) via a power cable or the like that physically connects the NMD 703 to an electrical outlet or some other external power source. Other power components may include, for example, transformers, converters, and like components configured to format electrical power.

In some implementations, the power components 727 of the NMD 703 may additionally include an internal power source 729 (e.g., one or more batteries) configured to power the NMD 703 without a physical connection to an external power source. When equipped with the internal power source 729, the NMD 703 may operate independent of an external power source. In some such implementations, the external power source interface 728 may be configured to facilitate charging the internal power source 729. As discussed before, a NMD comprising an internal power source may be referred to herein as a “portable NMD.” On the other hand, a NMD that operates using an external power source may be referred to herein as a “stationary NMD,” although such a device may in fact be moved around a home or other environment (e.g., to be connected to different power outlets of a home or other building).

The NMD 703 further includes a user interface 740 that may facilitate user interactions independent of or in conjunction with user interactions facilitated by one or more of the controller devices 104. In various embodiments, the user interface 740 includes one or more physical buttons and/or supports graphical interfaces provided on touch sensitive screen(s) and/or surface(s), among other possibilities, for a user to directly provide input. The user interface 740 may further include one or more of lights (e.g., LEDs) and the speakers to provide visual and/or audio feedback to a user.

As an illustrative example, FIG. 7B shows an isometric view of the NMD 730. As shown in FIG. 7B, the NMD 730 includes a housing 730. The housing 730 may carry one or more components shown in FIG. 7A. The housing 730 includes a user interface 740a carried on the top portion 734 of the housing 730. The user interface 740 includes buttons 736a-736c for controlling audio playback, volume level, and other functions. The user interface 740a also includes a button 736d for toggling the microphones 722 to either an on state or an off state.

As further shown in FIG. 7B, apertures are formed in the top portion 734 of the housing 730 through which the microphones 722 receive sound in the environment of the NMD 703. The microphones 722 may be arranged in various positions along and/or within the top portion 734 or other areas of the housing 730 so as to detect sound from one or more directions relative to the NMD 703.

FIG. 7C is a functional block diagram showing aspects of an NMD 703 configured in accordance with embodiments of the disclosure. As described in more detail below, the NMD 703 is configured to handle certain voice inputs locally, without necessarily transmitting data representing the voice input to a VAS. The NMD 703 is also configured to process other voice inputs using a voice assistant service.

Referring to the FIG. 7C, the NMD 703 includes a voice front end 757 (also referred to as voice capture components). The microphones 722 of the NMD 703 are configured to provide detected sound, S_{D}, from the environment of the NMD 703 to the voice front end 757. The detected sound S_{D} may take the form of one or more analog or digital signals. In example implementations, the detected sound S_{D} may be composed of a plurality signals associated with respective channels that are fed to the voice front end 757.

Each channel may correspond to a particular microphone 722. For example, an NMD having six microphones may have six corresponding channels. Each channel of the detected sound S_{D} may bear certain similarities to the other channels but may differ in certain regards, which may be due to the position of the given channel's corresponding microphone relative to the microphones of other channels. For example, one or more of the channels of the detected sound S_{D} may have a greater signal to noise ratio (“SNR”) of speech to background noise than other channels.

The voice front end 757 may include various components to facilitate conditioning and/or initial processing of the detected sound, S_{D}, such as an AEC, a spatial processor, and one or more buffers. In operation, the AEC receives the detected sound S_{D} and filters or otherwise processes the sound to suppress echoes and/or to otherwise improve the quality of the detected sound S_{D}. That processed sound may then be passed to the spatial processor.

The spatial processor is typically configured to analyze the detected sound S_{D} and identify certain characteristics, such as a sound's amplitude (e.g., decibel level), frequency spectrum, directionality, etc. In one respect, the spatial processor 764 may help filter or suppress ambient noise in the detected sound S_{D} from potential user speech based on similarities and differences in the constituent channels of the detected sound S_{D}, as discussed above. As one possibility, the spatial processor may monitor metrics that distinguish speech from other sounds. Such metrics can include, for example, energy within the speech band relative to background noise and entropy within the speech band—a measure of spectral structure—which is typically lower in speech than in most common background noise. In some implementations, the spatial processor 764 may be configured to determine a speech presence probability, examples of such functionality are disclosed in U.S. patent application Ser. No. 15/984,073, filed May 18, 2018, titled “Linear Filtering for Noise-Suppressed Speech Detection,” which is incorporated herein by reference in its entirety.

In operation, the one or more buffers—one or more of which may be part of or separate from the memory 713 (FIG. 7A)—capture data corresponding to the detected sound S_{D}. More specifically, the one or more buffers capture detected-sound data that was processed by the upstream AEC and spatial processor.

The detected-sound data forms a digital representation (i.e., sound-data stream), S_{DS}, of the sound detected by the microphones 722. In practice, the sound-data stream S_{DS} may take a variety of forms. As one possibility, the sound-data stream S_{DS} may be composed of frames, each of which may include one or more sound samples. The frames may be streamed (i.e., read out) from the one or more buffers for further processing by downstream components, such as the wake-word engines 758 and the voice extractor 759 of the NMD 703.

In some implementations, at least one buffer captures detected-sound data utilizing a sliding window approach in which a given amount (i.e., a given window) of the most recently captured detected-sound data is retained in the at least one buffer while older detected-sound data is overwritten when it falls outside of the window. For example, at least one buffer may temporarily retain 20 frames of a sound specimen at given time, discard the oldest frame after an expiration time, and then capture a new frame, which is added to the 19 prior frames of the sound specimen.

In practice, when the sound-data stream S_{DS} is composed of frames, the frames may take a variety of forms having a variety of characteristics. As one possibility, the frames may take the form of audio frames that have a certain resolution (e.g., 16 bits of resolution), which may be based on a sampling rate (e.g., 44,100 Hz). Additionally, or alternatively, the frames may include information corresponding to a given sound specimen that the frames define, such as metadata that indicates frequency response, power input level, SNR, microphone channel identification, and/or other information of the given sound specimen, among other examples. Thus, in some embodiments, a frame may include a portion of sound (e.g., one or more samples of a given sound specimen) and metadata regarding the portion of sound. In other embodiments, a frame may only include a portion of sound (e.g., one or more samples of a given sound specimen) or metadata regarding a portion of sound.

In any case, downstream components of the NMD 703 may process the sound-data stream S_{DS}. These downstream components include one or more wake-word engine(s) 758, a local voice input pipeline 760, and a mini-SLU pipeline 770, among other possible components. These downstream components may be referred to collectively as the voice back-end.

The wake-word engine(s) 758 may include one or more VAS wake-word engines 758a, which are configured to apply one or more identification algorithms to the sound-data stream S_{DS} (e.g., streamed sound frames) to spot potential wake words in the detected-sound S_{D}. Example wake word detection algorithms accept audio as input and provide an indication of whether a wake word is present in the audio. Many first- and third-party wake word detection algorithms are known and commercially available. For instance, operators of a voice service may make their algorithm available for use in third-party devices. Alternatively, an algorithm may be trained to detect certain wake-words.

For instance, when the VAS wake-word engine(s) 758a detects a potential VAS wake word, the VAS wake-word engines 758a provides an indication of a “VAS wake-word event” (also referred to as a “VAS wake-word trigger”). In the illustrated example of FIG. 7A, the VAS wake-word engine(s) 758a outputs a signal S_{VW} that indicates the occurrence of a VAS wake-word event to the voice extractor 759.

In some multi-VAS implementations, the NMD 703 may include a VAS selector (not shown) that is generally configured to direct extraction by the voice extractor 759 and transmission of the sound-data stream S_{DS} to the appropriate VAS when a given wake-word is identified by a particular wake-word engine (and a corresponding wake-word trigger) of the wake-word engines 758. In such implementations, the NMD 703 may include multiple, different VAS wake-word engines and/or voice extractors, each supported by a respective VAS.

Similar to the discussion above, each VAS wake-word engine 758a may be configured to receive as input the sound-data stream S_{DS} from the one or more buffers and apply identification algorithms to cause a wake-word trigger for the appropriate VAS. Thus, as one example, the VAS wake-word engine 758a may be configured to identify the wake word “Alexa” and cause the NMD 703a to invoke the AMAZON VAS when “Alexa” is spotted. As another example, another VAS wake-word engine may be configured to identify the wake word “Ok, Google” and cause the NMD 520 to invoke the GOOGLE VAS when “Ok, Google” is spotted. In single-VAS implementations, the VAS selector may be omitted.

In response to the VAS wake-word event (e.g., in response to the signal S_{VW} indicating the wake-word event), the voice extractor 759 is configured to receive and format (e.g., packetize) the sound-data stream S_{DS}. For instance, the voice extractor 759 packetizes the frames of the sound-data stream S_{DS} into messages. The voice extractor 759 transmits or streams these messages, M_{V}, that may contain voice input in real time or near real time to a remote VAS via the network interface 724.

In some implementations, a user may selectively enable or disable voice input processing via cloud-based voice assistant services. In some examples, to disable the voice input processing via cloud-based voice assistant services, the NMD 703 physically or logically disables the VAS wake-word engine(s) 758a. For instance, the NMD 703 may physically or logically prevent the sound-data stream S_{DS} from the microphones 722 from reaching the VAS wake-word engine(s) 758a and/or voice extractor 759. Suppressing generation may involve gating, blocking or otherwise preventing output from the VAS wake-word engine(s) 758a from generating a VAS wake-word event.

As described in connection with FIG. 2C, the voice input 755 may include a keyword portion and an utterance portion. The keyword portion may correspond to detected sound that causes a VAS wake-word event (i.e., a VAS wake word). Alternatively, the keyword portion may correspond to a local keyword, which may generate a local keyword event.

For instance, when the voice input 755 includes a VAS wake word, the keyword portion corresponds to detected sound that causes the VAS wake-word engine 758a to output the wake-word event signal S_{VW} to the voice extractor 759. The utterance portion in this case corresponds to detected sound that potentially comprises a user request following the keyword portion.

When a VAS wake-word event occurs, the VAS may first process the keyword portion within the sound-data stream S_{DS} to verify the presence of a VAS wake word. In some instances, the VAS may determine that the keyword portion comprises a false wake word (e.g., the word “Election” when the word “Alexa” is the target VAS wake word). In such an occurrence, the VAS may send a response to the NMD 703 with an instruction for the NMD 703 to cease extraction of sound data, which causes the voice extractor 759 to cease further streaming of the detected-sound data to the VAS. The VAS wake-word engine 758a may resume or continue monitoring sound specimens until it spots another potential VAS wake word, leading to another VAS wake-word event. In some implementations, the VAS does not process or receive the keyword portion but instead processes only the utterance portion.

In any case, the VAS processes the utterance portion to identify the presence of any words in the detected-sound data and to determine an underlying intent from these words. The words may correspond to one or more commands, as well as certain keywords. The keyword may be, for example, a word in the voice input identifying a particular device or group in the MPS 100. For instance, in the illustrated example, the keyword may be one or more words identifying one or more zones in which the music is to be played, such as the Living Room and the Dining Room (FIG. 1A).

To determine the intent of the words, the VAS is typically in communication with one or more databases associated with the VAS (not shown) and/or one or more databases (not shown) of the MPS 100. Such databases may store various user data, analytics, catalogs, and other information for natural language processing and/or other processing. In some implementations, such databases may be updated for adaptive learning and feedback for a neural network based on voice-input processing. In some cases, the utterance portion may include additional information such as detected pauses (e.g., periods of non-speech) between words spoken by a user, as shown in FIG. 2C. The pauses may demarcate the locations of separate commands, keywords, or other information spoken by the user within the utterance portion.

After processing the voice input, the VAS may send a response to the MPS 100 with an instruction to perform one or more actions based on an intent it determined from the voice input. For example, based on the voice input, the VAS may direct the MPS 100 to initiate playback on one or more of the playback devices 102, control one or more of these playback devices 102 (e.g., raise/lower volume, group/ungroup devices, etc.), or turn on/off certain smart devices, among other actions. After receiving the response from the VAS, the wake-word engine 771a of the NMD 703 may resume or continue to monitor the sound-data stream S_{DS} until it spots another potential wake-word, as discussed above.

In general, the one or more identification algorithms that a particular VAS wake-word engine, such as the VAS wake-word engine 758a, applies are configured to analyze certain characteristics of the detected sound stream S_{DS} and compare those characteristics to corresponding characteristics of the particular VAS wake-word engine's one or more particular VAS wake words. For example, the wake-word engine 758a may apply one or more identification algorithms to spot spectral characteristics in the detected sound stream S_{DS} that match the spectral characteristics of the engine's one or more wake words, and thereby determine that the detected sound S_{D} comprises a voice input including a particular VAS wake word.

In some implementations, the one or more identification algorithms may be third-party identification algorithms (i.e., developed by a company other than the company that provides the NMD 703a). For instance, operators of a voice service (e.g., AMAZON) may make their respective algorithms (e.g., identification algorithms corresponding to AMAZON's ALEXA) available for use in third-party devices (e.g., the NMDs 103), which are then trained to identify one or more wake words for the particular voice assistant service. Additionally, or alternatively, the one or more identification algorithms may be first-party identification algorithms that are developed and trained to identify certain wake words that are not necessarily particular to a given voice service. Other possibilities also exist.

As noted above, the NMD 703a also includes a local keyword engine 758b in parallel with the VAS wake-word engine 758a. Like the VAS wake-word engine 758a, the local keyword engine 758b may apply one or more identification algorithms corresponding to one or more keywords. A “local keyword event” is generated when a local keyword is identified in the detected-sound Sp. As shown in FIG. 7C, the VAS wake-word engine 758a and local keyword engine 758b apply different identification algorithms corresponding to their respective wake words, and further generate different events based on detecting a wake word in the detected-sound Sp. In some implementations, the VAS wake-word engine 758a and the local keyword engine 758b are implemented in the same logical unit configured to detect multiple keywords (e.g., VAS wake words and local keywords) and generate respective events corresponding to the different keywords.

Local keywords may take the form of command keywords. In contrast to the nonce words typically as utilized as VAS wake words, command keywords function as both the activation word and the command itself. For instance, example command keywords may correspond to playback commands (e.g., “play,” “pause,” “skip,” etc.) as well as control commands (“turn on”), among other examples. Under appropriate conditions, based on detecting one of these command keywords, the NMD 703a performs the corresponding command. Examples of command keyword eventing are described in U.S. patent application Ser. No. 16/439,009, filed Jun. 12, 2019, titled “Network Microphone Device with Command Keyword Conditioning,” which is incorporated by reference in its entirety. As noted above, utilizing command keywords instead of nonce keywords may allow a user to interact with the NMD 703 more naturally, without having to preface their voice input with the nonce keyword.

On the other hand, some implementations may utilize a one or more local keywords that take the form of a nonce wake word corresponding to local processing (e.g,. “Hey Sonos”), which is different from the VAS wake words corresponding to respective voice assistant services. Exemplary local wake-word detection is described in “Efficient keyword spotting using dilated convolutions and gating,” by Alice Coucke et al., published on Nov. 19, 2018, available at https://arxiv.org/pdf/1811.07684.pdf, which is incorporated by reference herein in its entirety and reproduced below in Appendix A. In such examples, the NMD 703 may utilize such keywords to trigger local keyword events, perhaps as an alternative to or in addition to command keywords.

As noted above, the local voice input pipeline 760 may also process the sound-data stream S_{DS}. The local voice input pipeline 760 includes an automatic speech recognizer (ASR) 761, which is configured to process the sound-data stream S_{DS} and output phonetic or phenomic representations, such as text corresponding to words. For instance, the ASR 761 may transcribe spoken words represented in the sound-data stream S_{DS} to one or more strings representing the voice input 755.

The ASR 761 can feed ASR output (labeled as SASR) to a local natural language unit (NLU) 762 that identifies particular keywords as being local keywords for invoking local-keyword events, as described below.

Exemplary automatic speech recognition is described in “Snips Voice Platform: an embedded Spoken Language Understanding system for private-by-design voice interfaces,” by Alice Coucke et al., published on May 25, 2018, and available at https://arxiv.org/pdf/1805.10190.pdf, which is incorporated by reference herein in its entirety.

When the local keyword engine 758b detects a keyword in the sound-data stream S_{DS}, the local keyword engine 758b generates a local keyword event. This local keyword event triggers the local voice input pipeline 760 to process the portion of the sound-data stream S_{DS} as a voice input. That is, the local NLU 762 may perform keyword spotting on the portions of the ASR output corresponding to the detected keyword, including portions of SASR before and after the detected keyword.

The local voice input pipeline 760 may generate confidence scores representing how closely the voice input matches the determined intent. As noted above, the local voice input pipeline 760 may perform keyword spotting on the output of the ASR 761. In some cases, the local voice input pipeline 760 may generate confidence scores indicating likelihood of spotting the keywords. The local voice input pipeline 760 may generate a confidence score for the voice input as a whole based on the individual confidence scores for the spotted keywords.

The local NLU 762 includes a keyword library (i.e., words and phrases) corresponding to respective commands and/or parameters. The local NLU 762 may derive an underlying intent from the detected keywords in the voice input 755. For instance, if the local NLU 762 matches the keywords “David Bowie” and “kitchen” in combination with a play command, the local NLU 762 may determine that the intent of the voice input is to play David Bowie in the Kitchen 101h on the playback device 102i. In contrast to a processing of the voice input 755 by a cloud-based VAS, local processing of the voice input 755 by the local NLU 762 may be relatively less sophisticated, as the NLU 762 does not have access to the relatively greater processing capabilities and larger voice databases that a VAS generally has access to.

In some examples, the local NLU 762 may determine an intent with one or more slots, which correspond to respective keywords. For instance, referring back to the play David Bowie in the Kitchen example, when processing the voice input, the local NLU 762 may determine that an intent is to play music (e.g., intent=playMusic), while a first slot includes David Bowie as target content (e.g., slot1=DavidBowie) and a second slot includes the Kitchen 101h as the target playback device (e.g., slot2=kitchen). Here, the intent (to “playMusic”) is based on the command keyword and the slots are parameters modifying the intent to a particular target content and playback device.

Certain parameter keywords may have a corresponding classification. For instance, some keywords may be designed as target keywords, which may refer to devices or groups of devices, perhaps by a zone or Room name. Other keywords may be classified as content keywords, which may refer to different media items by name or type. These classifications may assist the NMD 703 in slotting keywords to parameter slots.

For instance, an example voice input 755 may be “play music at low volume” with “play” being the command keyword portion (corresponding to a playback command) and “music” “low volume” being parameter keywords. When deriving an intent of this voice input 755, the local NLU 762 may slot these parameters as modifiers to the command keyword play to derive an intent. Further, various keywords may have classifications to assist in slotting the parameters.

In a second example, another example voice input 755 may be “play my favorites in the Kitchen” with “play” again being the command keyword portion (corresponding to a playback command) and “my favorites” and “Kitchen” as detected parameter keywords. When analyzing this voice input 755, after detecting the command keyword “play,” the local NLU 762 attempts to slot the other detected keywords as parameters to that command. “Kitchen” may slot in as a first parameter representing a target for the playback command (i.e., the kitchen 101h zone. Further “favorites” corresponds to a second parameter corresponding to particular audio content (i.e., a particular playlist that includes a user's favorite audio tracks).

In a third example, a further example voice input 755 may be “volume up” with “volume” being the command keyword portion (corresponding to a volume adjustment command) and “up” being a parameter keyword. When analyzing this voice input 755, after detecting the command keyword “volume,” the local NLU 762 attempts to slot the other detected keyword as a parameter to that command. “Up” may slot in as a first parameter representing a certain volume increase (e.g., a 10 point increase on a 100 point volume scale).

Other example voice inputs may relate to smart device commands. For instance, an example voice input 755 may be “turn on patio lights” with “turn on” being the command keyword portion (corresponding to a power on command) and “patio” and “lights” being the parameter keywords. When analyzing this voice input 755, after detecting the command keyword “turn on,” the local NLU 762 attempts to slot the other detected keywords as parameters to that command. In particular, if “patio” is classified as a target parameter, the mini-SLU pipeline 770 may slot that as the target for the command. As another example, another example voice input 755 may be “set temperature to 75” with “set temperature” being the command keyword portion (corresponding to a thermostat adjustment command) and “to 75” being the voice utterance portion. When analyzing this voice input 755, the NLU 776 may recognize that “to 75” is a keyword in its library 778 corresponding to a parameter representing a setting for the thermostat adjustment command. Accordingly, the NLU 776 may determine an intent to set a smart thermostat to 75 degrees.

Some commands may require one or more parameters, as such the command keyword alone does not provide enough information to perform the corresponding command. For example, the command keyword “volume” might require a parameter to specify a volume increase or decrease, as the intent of “volume” of volume alone is unclear. As another example, the command keyword “group” may require two or more parameters identifying the target devices to group.

Accordingly, in some example implementations, when a given local wake-word is detected in the voice input 755 by the local voice input pipeline, 760 the local NLU 762 may determine whether the voice input 755 includes keywords corresponding to the required parameters. If the voice input 755 does include keywords matching the required parameters, the NMD 703 proceeds to perform the command (corresponding to the given command keyword) according to the parameters specified by the keywords.

However, if the voice input 755 does not include keywords matching the required parameters for the command, the NMD 703 may prompt the user to provide the parameters. For instance, in a first example, the NMD 703 may play an audible prompt such as “I′ve heard a command, but I need more information” or “Can I help you with something?” Alternatively, the NMD 703 may send a prompt to a user's personal device via a control application (e.g., the software components 132c of the control device(s) 104).

Within additional examples, when a voice utterance portion does not include keywords corresponding to one or more required parameters, the NMD 703 may perform the corresponding command according to one or more default parameters. For instance, if a playback command does not include keywords indicating target playback devices 102 for playback, the NMD 703 may default to playback on the NMD 703 itself (e.g., if the NMD 703a is implemented within a playback device 102) or to target one or more associated playback devices 102 (e.g., playback devices 102 in the same room or zone as the NMD 703a). Further, in some examples, the user may configure default parameters using a graphical user interface (e.g., user interface 430) or voice user interface. For example, if a grouping command does not specify the playback devices 102 to group, the NMD 703 may default to instructing two or more pre-configured default playback devices 102 to form a synchrony group. Default parameters may be stored in data storage (e.g., the memory 112b (FIG. 1F)) and accessed when the NMD 703a determines that keywords exclude certain parameters. Other examples are possible as well.

As noted above, a mini-SLU pipeline 770 may monitor the sound-data stream S_{DS}. The mini-SLU pipeline 770 includes a hybrid keyword detector 771, which is configured to spot keywords. In contrast to keyword spotting via the local NLU 762, the hybrid keyword detector 771 spots keywords in the sound-data stream S_{DS} rather than in the ASR output SASR. While the local voice input pipeline 760 is shown as a parallel pipeline by way of example, in some examples, the NMD 703 might not include the local voice input pipeline 760.

The hybrid keyword detector 771 may be configured to detect pre-loaded keywords. Pre-loaded keywords may include both command keywords as well as commonly-used parameters corresponding to the commands. The set of keywords implemented in a given NMD may be task-based. For instance, if the NMD 703 is implemented in the media playback system 100 (FIG. 1A), the NMD 703 may be trained to detect keywords corresponding to playback commands such as “play,” “pause,” or “skip.” In some cases, the pre-loaded keywords correspond to other tasks, such as control of various IoT devices like the one or more smart illumination devices 108 or smart thermostat 110 (FIG. 1B). Further, in some cases, the hybrid keyword detector 771 may be configured to detect pre-loaded keywords corresponding to two or more tasks, such as control of different types of smart devices in the same household.

In some examples, the hybrid keyword detector 771 is configured to detect custom keywords. In various examples, a user may define custom keywords via a user interface, such as the user interface 440 (FIG. 4) on a control device 104 or the user interface 740 on the NMD 703 (FIG. 7A). Custom keywords may correspond to custom commands, such as a custom command (“party time”) to enable a custom scene (e.g., grouping playback devices into a synchrony group to play back a particular party playlist in synchrony).

When the hybrid keyword detector 771 detects a keyword in the sound-data stream S_{DS}, the hybrid keyword detector 771 generates a keyword detection event. This keyword detection event triggers the mini-SLU pipeline 770 to process the portion of the sound-data stream S_{DS} as a voice input. With the mini-SLU pipeline 770, presence of a keyword in the voice input indicates intent to perform the command associated with the keyword. In other words, intent to perform a command is directly based on presence of the keyword corresponding to that command. Within examples, the NMD 703 may maintain or have access to data correlating the keywords to corresponding commands. In this manner, intent determination is relatively quicker and less resource intensive as compared with other voice input processing pipelines.

In some cases, a given command may be associated with two or more keywords. In such examples, the mini-SLU pipeline 770 may determine intent to perform the command by detecting whether the two or more keywords are present in the voice input. Presence of one keyword associated with a given command in a voice input may prompt the mini-SLU pipeline 770 to determine whether the other keyword is present in the voice input. For instance, if the hybrid keyword detector 771 spots the keyword “volume” in a voice input, the mini-SLU pipeline 770 may determine whether the keywords “up” or “down” are also present in the voice input. In this manner, the mini-SLU pipeline 770 may determine intent based on presence without performing full spoken language understanding.

As indicated above, in some cases, the hybrid keyword detector 771 is configured to spot parameter keywords. For instance, if the NMD 703 is implemented in the media playback system 100 (FIG. 1A), the NMD 703 may be trained to detect playback-related parameters. Pre-loaded parameter keywords may include commonly used names of playback targets (e.g., names of Rooms or zones commonly found in a household, such as “Living Room,” “Kitchen” or “Master Bedroom”) as illustrated by the zones of the media playback system 100 (FIG. 1A). Within examples, a user may add custom keywords such as playlist names or the names of favorite artists, albums, or other metadata, as well as the names of custom playback targets (e.g., custom zones names).

To maintain the small footprint of the mini-SLU pipeline 770, it is generally impractical to train the hybrid keyword detector 771 to detect many items of metadata, such as the metadata of the millions of audio tracks provided by a streaming media service. Generally, voice inputs referencing metadata outside of a subset of user favorites are handled by a more capable processing pipeline, such as the local voice input pipeline or cloud-based voice assistant processing. In this design, the user is able to customize the mini-SLU pipeline 770 to handle certain commands and parameters quickly, while maintaining the more capable (albeit slower) parallel processing pipeline(s) for queries outside of the scope of the mini-SLU pipeline 770.

In operation, the hybrid keyword detector 771 may generate confidence scores predicting whether a portion of the sound-data stream S_{DS} (e.g., a time segment) includes each keyword. In example implementations, when the probability of detecting a keyword exceeds a threshold, the segment is determined to include that keyword. In an example implementation, when a keyword is detected, the hybrid keyword detector 771 generates a keyword detection event to process the portion of the sound-data stream S_{DS} including the keyword as a voice input. The hybrid keyword detector 771 may lower the threshold for recognizing other portions of the of the sound-data stream S_{DS} in proximity to the detected keyword as including keywords on the basis that these portions are more likely to be part of the voice input (and not false positives).

The hybrid keyword detector 771 may implement a neural architecture to spot keywords. FIG. 7D illustrates an example neural architecture 775, which may be implemented in the hybrid keyword detector 771. In operation, the neural architecture 775 takes input from the sound-data stream S_{DS} and generates confidence scores C₁, C₂, . . . C_{N} predicting whether a portion of the sound-data stream S_{DS} (e.g., a time segment) includes each keyword.

Aspects of example hybrid keyword detectors and mini-SLU pipelines can be found below in Appendix A, under the section title “Predicting detection filters for small footprint open-vocabulary keyword spotting.

As shown in FIG. 7D, the neural architecture 775 includes intermediate layers 776, which together form an acoustic encoder. In illustrative examples, the intermediate layers 776 are composed of a stack of long short-term memory (LTSM) layers pre-trained to generate quantized intermediate features from the sound-data stream S_{DS}. The intermediate layers can be represented mathematically as F(x; θ_{F}), where parameters θ_{F} are applied to input x.

The output layer 777 is a convolutional layer that predicts the probability of detecting each keyword at each timestep. The output layer 777 includes an output (referred to as a confidence score) (C₁, C₂, . . . C_{N}) corresponding to each keyword. Each confidence score reflects how closely the sound patterns in the voice input 755 match the sound patterns for the corresponding word. In examples, these confidences scores may be sigmoid outputs with values from 0-1 with 1 indicating a high probability of the sound-data stream S_{DS} including the keyword and 0 indicating a low probability. In such examples, for keyword k, the output sequence yₖ is computed as follows:

$${y}_{k} = {y}_{k , 1} … {y}_{k , T} = σ ( {θ}_{k} * F ( x ; {θ}_{F} ) )$$

where σ is the sigmoid function, * is the convolution operation, and F(x; θ_{F}) represents the intermediate layers 776 applied to input x, and θₖ is the convolutional kernel corresponding to keyword k.

The keyword encoder 778 is an auxiliary neural network configured to predict the parameters θₖ used to detect the keyword. The keyword encoder 778 can be represented as:

$${θ}_{k} = E ( {π}_{k} ; {θ}_{E} )$$

where θ_{E} represents the parameters of the neural network of the keyword encoder 779 and πₖ is the phone sequence of the keyword k. The keyword encoder 779 allows custom (i.e., user-defined) keywords to be adopted by the neural architecture 775. That is, when provided a custom keyword k_{cust} (e.g., “party time”), the keyword encoder 779 predicts the parameters θₖ used to detect the custom keyword. These parameters are then convoluted with the input x to generate a confidence score C_{cust} whether the input x includes the custom keyword.

At inference, the neural architecture 775 may be pre-trained to detect a set of pre-loaded keywords K=k₁, . . . , kₙ. These keywords may include command keywords for a specific task or tasks, such as playback (e.g., play, pause, skip, etc.) as well as common parameters for the tasks (e.g., playback zones such as “Living Room” or “Kitchen”). For each keyword k∈K, the phone sequence πₖ is retrieved from a pronunciation lexicon or generated using a phone sequence converter 779 and the convolution kernel θₖ is computed using the keyword encoder 779. Then, the output layer 777 can be created with the set of computed kernels {θₖ; k∈K} to make the neural architecture ready to process the input data.

Within examples, the intermediate layers 776 and the keyword encoder 778 may be jointly trained using generic speech training set D={(x⁽ⁱ⁾, π⁽ⁱ⁾)} without knowing all of the final keywords used in operation. Combining the intermediate layers 776, the output layer 777, and the keyword encoder 778 yields:

$${y}_{k} = σ ( E ( {π}_{k} ) * F ( x ) ) .$$

For each time step t of each training sample x, the training set includes a set

$${K}_{i , t}^{+}$$

of positive examples for πₖ (where y_{k,t} is close to 1) and a set

$${K}_{i , t}^{-}$$

of negative examples for πₖ (where y_{k,t} is close to 0). Then, in training, the following loss is minimized:

$${L}_{KWS} = {\sum }_{{x}^{( i )} , {π}^{( i )} ∈ D} {\sum }_{t} l ( i , t ) where$$

$$l ( i , t ) = - {\sum }_{k ∈ {K}_{i , t}^{-}} log ( 1 - {y}_{k , t}^{( i )} ) - {\sum }_{k ∈ {K}_{i , t}^{+}} log ( {y}_{k , t}^{( i )} ) .$$

In some examples, the output layer 777 may be further trained based on keyword-specific data, which increase the probability of detecting certain keywords (e.g., pre-loaded keywords) relative to other keywords (e.g., custom keywords). More particularly, the weights generated by the keyword encoder 778 when training on generic speech data may be used as a started point for re-training on keyword-specific data (i.e., users speaking the keywords to be detected). In such cases, the weights of the output layer 777 can be represented as:

$${θ}_{k} = E ( {π}_{k} ; {θ}_{E} ) + {θ}_{k}^{( data )} .$$

Given a training set D_{K} for a set of keywords K composed of positive as well as negative data, the data specific parameters

$$\{ {θ}_{{k}_{k}}^{( data )} \} k ∈ K$$

can be adjusted to optimize the loss as noted above.

Referring together to FIGS. 7C and 7D, in some cases, the NMD 703 may determine a confidence score for the voice input as a whole, which may be based on confidence scores for the constituent keywords in the voice input. For instance, the NMD 703 may average or otherwise combine the individual keyword confidence scores to determine the confidence score for the voice input. Then, the NMD 703 may perform a command according to a determined intent when the confidence score for a given voice input exceeds a given threshold value (e.g., 0.5 on a scale of 0-1, indicating that the given sound is more likely than not the command keyword). Conversely, when the confidence score for a given intent is at or below the given threshold value, the NMD 703 does not perform the operation according to the determined intent.

As noted above, for certain keywords, such as pre-loaded keywords, the neural architecture 775 may have been trained with relatively more training data than other keywords, such as custom (e.g., user-defined) keywords. Custom keywords might not have any particular training data at all; instead, as discussed above, the weights used to detect custom keywords may be predicted by the keyword encoder 778, which itself was trained on generic speech data (and possibly additionally trained on keyword-specific data for the pre-loaded keywords). The hybrid keyword detector 771 may accordingly be able to detect any pre-loaded keywords in the voice input 755 with relatively more confidence than custom keywords.

In some cases, the voice input 755 includes both pre-loaded and custom keywords. For instance, when analyzing a given voice input (e.g., “play the party time playlist”), the NMD may inherently have relatively higher confidence in detecting pre-loaded keywords in this voice input (e.g., “play”) compared with detecting the custom keywords in the voice input (e.g., “party time playlist”) that were defined by the user. This increased confidence may come from increased training data for the pre-loaded keywords, as well as other adjustments made to the neural architecture to improve the ability of the hybrid keyword detector to spot the pre-loaded keywords. Since the custom keywords are defined by the user, it is not possible to train the neural architecture 775 with such keyword specific data.

In practice, many voice inputs include more than one keyword. Moreover, certain keywords are typically used in a voice input with other keywords. For instance, the command keyword “play” is often used with parameter keywords identifying what to play (which playlist, artist, song, station, etc.) and possibly where to play it (i.e., which zone), among other possible parameters. As another example, the command keyword “turn on” is often used with a parameter keyword identifying what to turn on.

Based on such practices, the mini-SLU pipeline 770 may be configured to derive a greater confidence level in spotting custom keywords when detecting such keywords in a voice input with pre-loaded keywords. That is, when the hybrid keyword detector 771 spots a pre-loaded keyword in a voice input with high confidence and also spots a custom keyword is in the voice input albeit with relatively lower confidence, the NMD 703 may increase the native confidence score for the custom keyword to indicate an increased confidence in spotting the keyword in the voice input. Such an adjustment to a custom keyword would increase the confidence for the voice input as a whole. Alternatively, the hybrid keyword detector 771 may assign a higher confidence to the voice input as a whole than would otherwise be assigned to a voice input with the constituent keywords. This functionality is based on this assumption that when the hybrid keyword detector 771 has spotted one or more keywords with high confidence, other sounds spoken with those high-confidence keywords are more likely to be keywords as well.

Similar processing techniques may be applied to other parallel processing pipelines. For instance, the local voice input pipeline 760 may be configured to derive a greater confidence level in spotting custom keywords when detecting such keywords in a voice input with pre-loaded keywords. That is, similar to the mini-SLU pipeline 770, when the local voice input pipeline 760 spots a pre-loaded keyword in a voice input with high confidence and also spots a custom keyword is in the voice input albeit with relatively lower confidence, the NMD 703 may increase the native confidence score for the custom keyword to indicate an increased confidence in spotting the keyword in the voice input. Such an adjustment to a consistent keyword would increase the confidence for the voice input as a whole. Alternatively, the NMD 703 may assign a higher confidence to the voice input as a whole than would otherwise be assigned to a voice input with the constituent keywords. Such processing techniques may also be applied to cloud-based processing by a voice assistant service that supports custom keywords.

Within examples, certain keywords are functionally linked to other keywords, which may allow the NMD 703 adjust the confidence score for a voice input based on the combination of keywords detected. For instance, the command keyword “skip” may be functionality linked to the keywords “forward” and “backward” and their cognates. Accordingly, when the command keyword “skip” is detected in a given voice input 755, the confidence for the voice input may be adjusted upwards when “backward” or “forward” is also detected. Conversely, the confidence for the voice input may be adjusted downwards when “backward” or “forward” is not detected.

Further, in some cases, the NMD 703 may functionally link one or more pre-loaded keywords with one or more custom keywords. For instance, when a user defines a custom keyword to refer to a particular playlist, the NMD 703 may functionally link that keyword with the command keyword “play”, as the user is likely to use the “play” command keyword in combination with the custom playlist parameter keyword. Then, if one of the functionality-linked keywords is detected in a voice input, the hybrid keyword detector 771 may adjust the confidence score if the other keyword is also detected in the voice input, albeit at a lower confidence.

In some implementations, a phrase may be used as a keyword, which provides additional patterns to match (or not match). For instance, a user may define a custom keyword of “Ron's Relaxation Lounge” to refer to playback devices in his den and the custom keyword “jams” to refer to a particular playlist. This user may then speak the voice input “Play jams in Ron's Relaxation Lounge.” Since the custom keyword has multiple patterns, the hybrid keyword detector 771 may typically detect it with a relatively high confidence as compared with “jams.” Accordingly, when detecting both “Ron's Relaxation Lounge” and “jams” the hybrid keyword detector 771 may increase the confidence score of “jams” (or the voice input as a whole).

As illustrated in FIG. 7C, the mini-SLU pipeline 770 may operate in parallel on the NMD 703 with cloud-based VAS processing and/or local processing via the local voice input pipeline 760 (referred to as parallel processing paths). Such parallel operation may result in parallel processing of a given voice input. For instance, the voice input “Siri, play me some Mitski” may trigger a VAS wake word event (based on the VAS wake word “Siri”) and also a keyword detection event (based on the keyword “play”). Duplicate processing of the voice input is undesirable as it may cause conflicting operations.

In some cases, the mini-SLU pipeline 770 is configured to stop processing of the voice input by the parallel processing paths when the mini-SLU pipeline 770 processes the voice input. The mini-SLU pipeline 770 is typically able to process voice inputs more quickly than the parallel processing paths, as the mini-SLU pipeline 770 does not perform ASR and does not have latency inherent in cloud-based processing. Due to the relatively quick response of the mini-SLU pipeline 770 relative to the parallel processing paths, the mini-SLU pipeline 770 may generally be first to process voice inputs in the sound-data stream S_{DS}. If the mini-SLU pipeline 770 completes processing (i.e., performs a command according to the determined intent), the mini-SLU pipeline 770 may stop processing by the parallel processing paths to avoid duplicate processing.

Alternatively, when detecting one or more keywords in the sound-data stream S_{DS}, the mini-SLU pipeline 770 may pause processing by the parallel processing paths. Then, if the mini-SLU pipeline 770 does not complete processing of the voice input (e.g., because the keywords were matched with low confidence), the mini-SLU pipeline 770 can resume processing by the parallel processing paths. This functionality allows the mini-SLU pipeline 770 to have a first opportunity to process the voice input for the benefit of quicker processing, but also maintain the parallel processing paths as backup to the mini-SLU pipeline 770.

In some implementations, the mini-SLU pipeline 770 sends the voice input 755 to a VAS when the mini-SLU pipeline 770 is unable to process the voice input 755 (e.g., when the mini-SLU pipeline 770 has a low confidence score keywords in the voice input 755). In an example, to trigger sending the voice input 755, the NMD 703 may generate a bridging event, which causes the voice extractor 759 to process the sound-data stream S_{DS}, as discussed above. That is, the NMD 703 generates a bridging event to trigger the voice extractor 759 without a VAS wake-word being detected by the VAS wake-word engine 758a (instead based on a keyword in the voice input 755, as well as the mini-SLU pipeline 770 being unable to process the voice input 755).

Since the hybrid keyword detector is monitoring for more keywords, including words that may be commonly used in conversation, the hybrid keyword detector 771 may be relatively more prone to false positive detections as compared with the wake-word engines 758 (which may be monitoring for a VAS wake-word). Further, the hybrid keyword detector 771 may monitor for keywords more commonly used in conversation as compared with nonce wake word used to trigger VAS wake-word events. False positive detections are undesirable as they may cause unintended commands to be performed, which may alter or interrupt operation of the controlled device(s).

The mini-SLU pipeline 770 may also include a speaker ID engine 773. The speaker ID engine 773 is configured to determine whether a voice input matches a pre-determined speaker profile. The NMD 703 may maintain (e.g., in the memory 713) or have access to (e.g., in the cloud) pre-determined speaker profiles corresponding to the users in a household (e.g., the media playback system 100 of FIG. 1A) as well as other users that have stored a profile with the system. When a voice input matches one of these pre-determined speaker profiles, confidence that the utterance was intended as a voice input to the NMD is increased.

In example implementations, the mini-SLU pipeline 770 does not perform any command according to the determined intent in a voice input unless the voice input matches a pre-determined speaker profile. That is, determining that the voice input matches a pre-determined speaker profile is a condition on whether the NMD 703 performs a command when the hybrid keyword detector 771 keywords corresponding to a voice input. This condition may reduce the prevalence of false positives by the mini-SLU pipeline 770, as the NMD 703 will respond only to known users.

When a voice input includes a custom keyword set up by a particular user, the speaker profile condition may further increase confidence by not performing a command corresponding to the determined intent of the voice input unless the voice input matches a pre-determined speaker profile of the particular user. For example, a particular user may set up a custom keyword such as “Party Time” to trigger a particular command or action (such as playback of a particular playlist across multiple (or all) playback devices in a household, as may be useful during a party). When the user utters the keyword “Party Time,” the detecting NMD may recognize that the utterance includes that keyword and further determine that the speaker of the utterance is the particular user. Since the speaker of the custom keyword is the particular user who configured the keyword, the NMD 703 is more confident that the detected utterance was intended as a voice input than the NMD 703 would otherwise be without this determination.

The speaker ID engine 773 may perform speaker recognition using any suitable technique. For example, the speaker ID engine 773 may implement a neural architecture to perform speaker identification on an utterance. The network is trained to take sound data (e.g., a spectrogram) as input and produce output representing similarity between one or more pre-determined speaker profiles and the input, which may correspond to users in a household (e.g., the media playback system 100 of FIG. 1A). In this manner, the speaker ID engine 773 determines whether the voice input 755 matches a pre-determined speaker profile. Although the speaker ID engine 773 is shown by way of example as following the hybrid keyword detector 771 in the mini-SLU pipeline 770, the speaker ID engine 773 may be implemented in parallel to the hybrid keyword detector 771 or as part of the voice front end 757.

Example techniques for speaker recognition at the edge are described in “Utterance-Level Aggregation For Speaker Recognition In the Wild,” by Weidi Xie et al., published on May 17, 2019, and available at https://arxiv.org/pdf/1902.10107.pdf, which is incorporated by reference herein in its entirety and reproduced below in Appendix A. Other suitable edge speaker recognition techniques may be utilized in various implementations. Speaker recognition techniques yet to be developed may increase accuracy and/or speed or speaker recognition at the cdgc.

As noted above, in some examples, detection of a known speaker profile is a condition on performing a command according to the intent of a voice input. In some cases, the NMD 703 imposes one or more additional conditions corresponding to the detected keywords in the voice input. These additional conditions may further lower the prevalence of false positives.

For instance, when a voice input includes a command keyword corresponding to a given command, the NMD 703 performs a command only when the targeted device(s) are in a state to perform the command. For instance, after detecting the command keyword “skip” as spoken by a known speaker profile, the NMD 703 performs skips to the next track) only when certain playback conditions indicating that a skip should be performed are met. These playback conditions may include, for example, (i) a first condition that a media item is being played back, (ii) a second condition that a queue is active, and (iii) a third condition that the queue includes a media item subsequent to the media item being played back. If any of these conditions are not satisfied, the command is not performed.

The NMD 703 may include one or more state machine(s) to facilitate determining whether the appropriate conditions are met. An example state machine transitions between a first state and a second state based on whether one or more conditions corresponding to the detected command keyword are met. In particular, for a given command keyword corresponding to a particular command requiring one or more particular conditions, the state machine 779a transitions into a first state when one or more particular conditions are satisfied and transitions into a second state when at least one condition of the one or more particular conditions is not satisfied.

Within example implementations, the command conditions are based on states indicated in state variables. As noted above, the devices of the MPS 100 may store state variables describing the state of the respective device in various aspects. For instance, the playback devices 102 may store state variables indicating the state of the playback devices 102, such as the audio content currently playing (or paused), the volume levels, network connection status, and the like). These state variables are updated (e.g., periodically, or based on an event (i.e., when a state in a state variable changes)) and the state variables further can be shared among the devices of the MPS 100, including the NMD 703.

Similarly, the NMD 703 may maintain these state variables (either by virtue of being implemented in a playback device or as a stand-alone NMD). The state machine(s) monitor the states indicated in these state variables, and determines whether the states indicated in the appropriate state variables indicate that the command condition(s) are satisfied. Based on these determinations, the state machines transition between the first state and the second state, as described above.

In some implementations, voice inputs containing certain command keywords are not performed unless certain conditions have been met via the state machines. For example, the first state and the second state of the state machine may operate as enable/disable toggles for a given command keyword. In particular, while a state machine corresponding to a particular command keyword is in the first state, the state machine enables performing the particular command keyword when detected by the hybrid keyword detector 771. Conversely, while the state machine corresponding to the particular command keyword is in the second state, the state machine disables performing the particular command keyword when detected by the hybrid keyword detector 771.

Other example conditions may be based on the output of a voice activity detector (“VAD”), which may be implemented in the voice front-end 757. The VAD is configured to detect the presence (or lack thereof) of voice activity in the sound-data stream S_{DS}. In particular, the VAD 76 may analyze frames corresponding to the pre-roll portion of the voice input 755 (FIG. 2D) with one or more voice detection algorithms to determine whether voice activity was present in the environment in certain time windows prior to a keyword portion of the voice input 755.

The VAD may utilize any suitable voice activity detection algorithms. Example voice detection algorithms involve determining whether a given frame includes one or more features or qualities that correspond to voice activity, and further determining whether those features or qualities diverge from noise to a given extent (e.g., if a value exceeds a threshold for a given frame). Some example voice detection algorithms involve filtering or otherwise reducing noise in the frames prior to identifying the features or qualities.

In some examples, the VAD may determine whether voice activity is present in the environment based on one or more metrics. For example, the VAD can be configured to distinguish between frames that include voice activity and frames that don't include voice activity. The frames that the VAD determines have voice activity may be caused by speech regardless of whether it near-or far-field. In this example and others, the VAD may determine a count of frames in the pre-roll portion of the voice input 755 that indicate voice activity. If this count exceeds a threshold percentage or number of frames, the VAD may be configured to output a signal or set a state variable indicating that voice activity is present in the environment. Other metrics may be used as well in addition to, or as an alternative to, such a count.

The presence of voice activity in an environment may indicate that a voice input is being directed to the NMD 703. Accordingly, when the VAD indicates that voice activity is not present in the environment (perhaps as indicated by a state variable set by the VAD) this may be configured as one of the command conditions for the local keywords. When this condition is met (i.e., the VAD indicates that voice activity is present in the environment), the state machine will transition to the first state to enable performing commands based on local keywords, so long as any other conditions for a particular local keyword are satisfied.

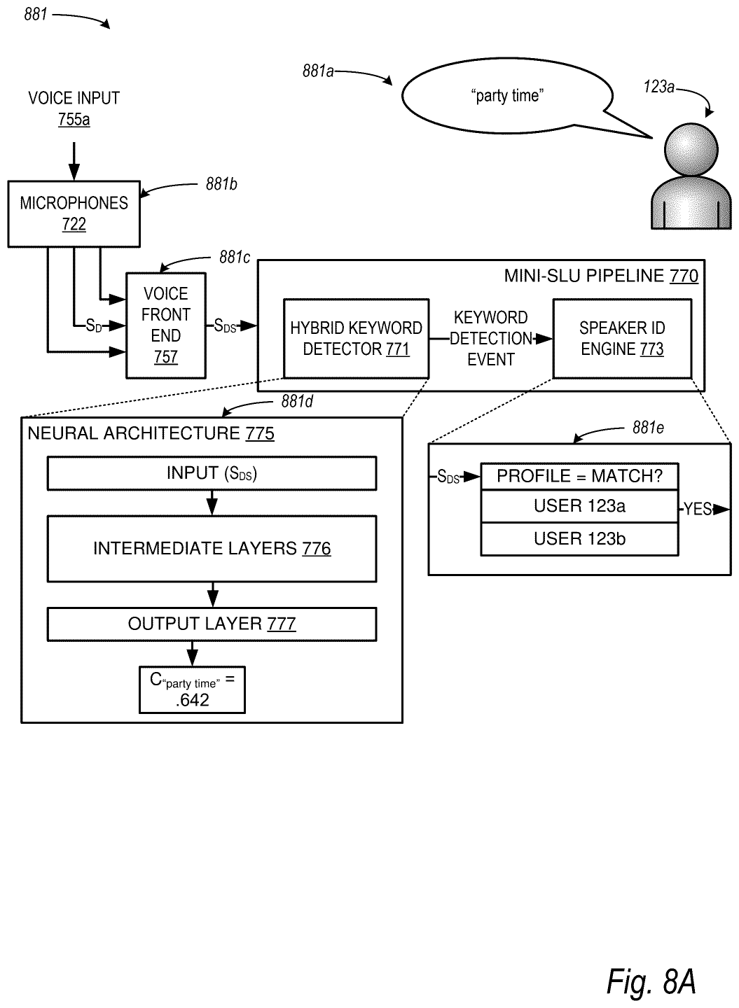

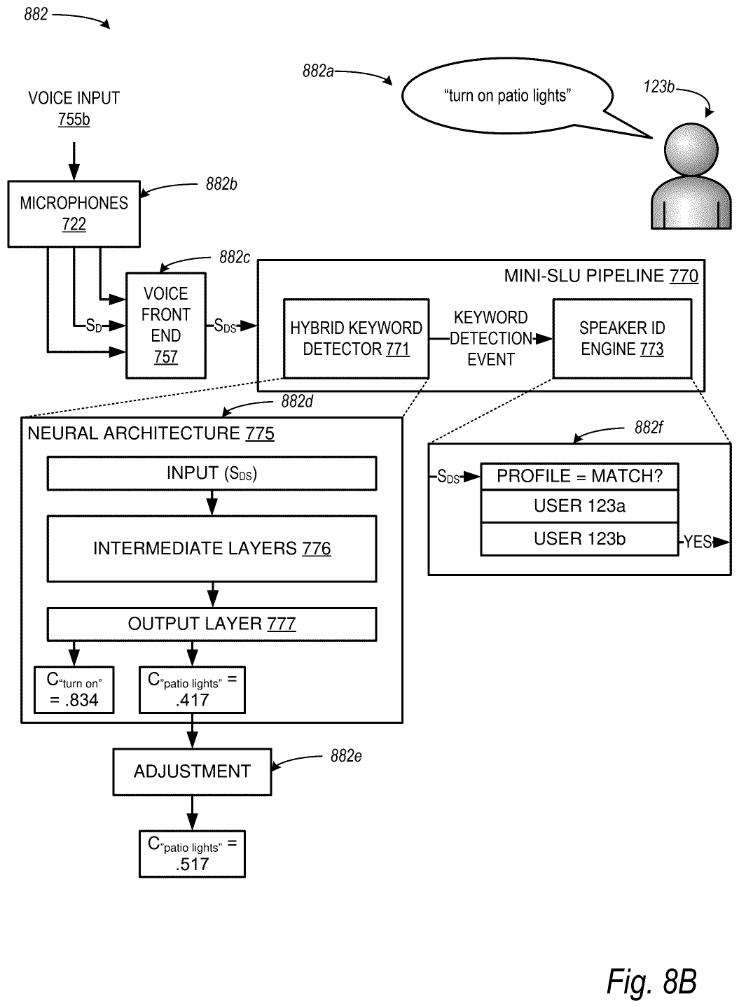

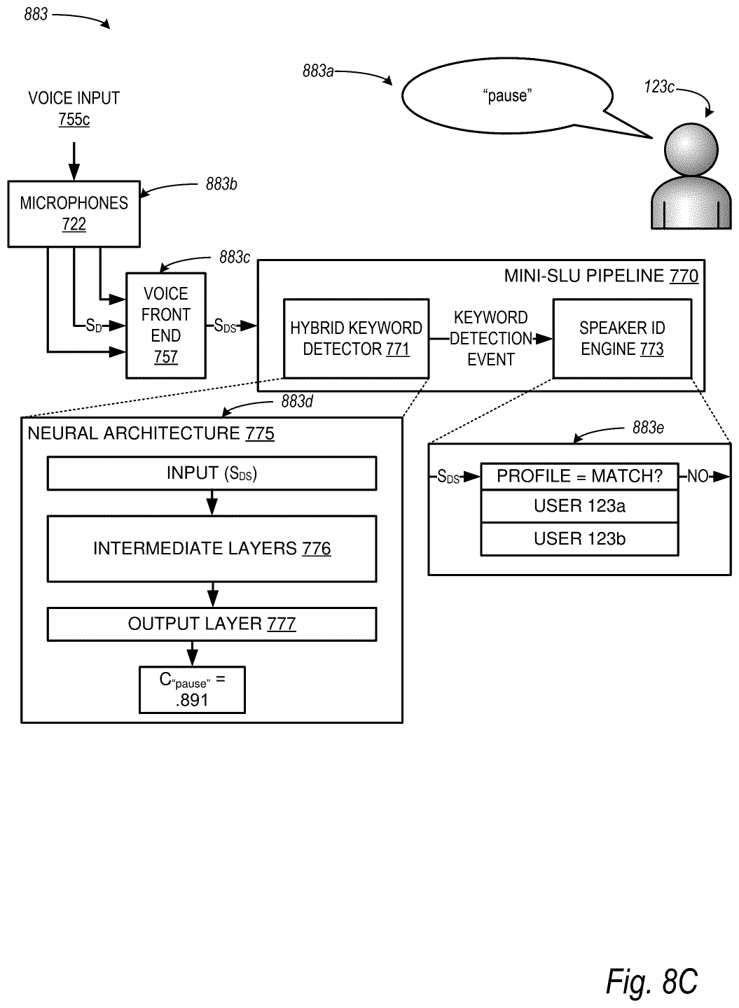

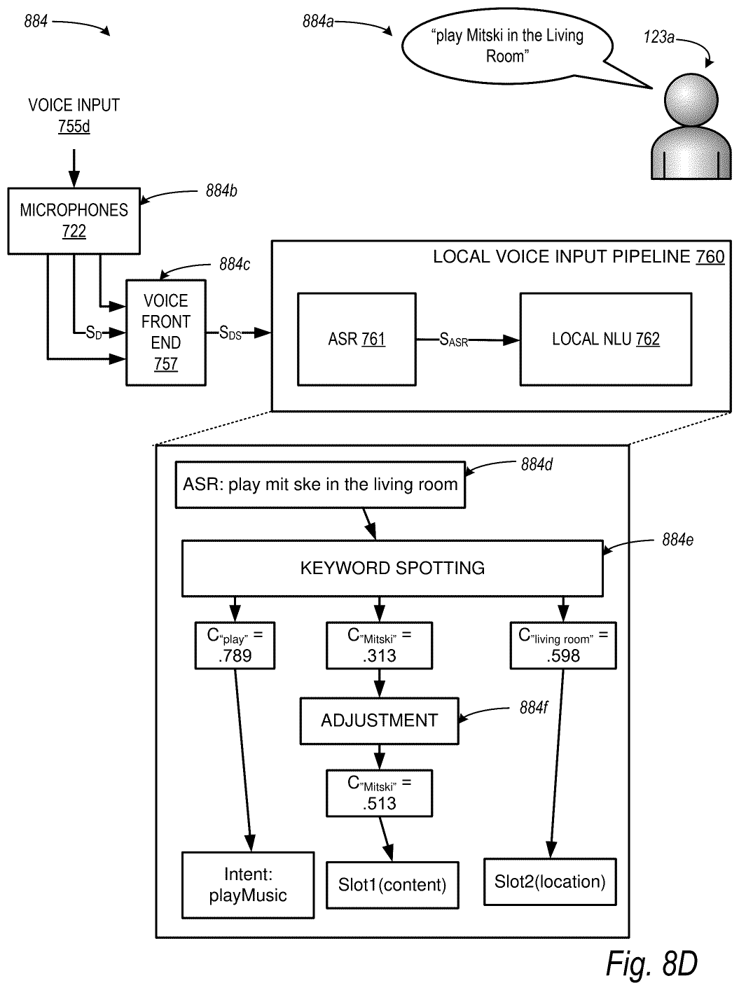

Further, in some implementations, the NMD 703 may include a noise classifier. The noise classifier is configured to determine sound metadata (frequency response, signal levels, etc.) and identify signatures in the sound metadata corresponding to various noise sources. The noise classifier may include a neural network or other mathematical model configured to identify different types of noise in detected sound data or metadata. One classification of noise may be speech (e.g., far-field speech). Another classification, may be a specific type of speech, such as background speech, an example of which is described in greater detail with reference to FIG. 8. Background speech may be differentiated from other types of voice-like activity, such as more general voice activity (e.g., cadence, pauses, or other characteristics) of voice-like activity detected by the VAD.

For example, analyzing the sound metadata can include comparing one or more features of the sound metadata with known noise reference values or a sample population data with known noise. For example, any features of the sound metadata such as signal levels, frequency response spectra, etc. can be compared with noise reference values or values collected and averaged over a sample population. In some examples, analyzing the sound metadata includes projecting the frequency response spectrum onto an eigenspace corresponding to aggregated frequency response spectra from a population of NMDs. Further, projecting the frequency response spectrum onto an eigenspace can be performed as a pre-processing step to facilitate downstream classification.

In various embodiments, any number of different techniques for classification of noise using the sound metadata can be used, for example machine learning using decision trees, or Bayesian classifiers, neural networks, or any other classification techniques. Alternatively or additionally, various clustering techniques may be used, for example K-Means clustering, mean-shift clustering, expectation-maximization clustering, or any other suitable clustering technique. Techniques to classify noise may include one or more techniques disclosed in U.S. application Ser. No. 16/227,308 filed Dec. 20, 2018, and titled “Optimization of Network Microphone Devices Using Noise Classification,” which is herein incorporated by reference in its entirety.

In some implementations, an additional buffer may store information (e.g., metadata or the like) regarding the detected sound S_{D} that was processed by the upstream AEC and spatial processor. This additional buffer may be referred to as a “sound metadata buffer.” Examples of such sound metadata include: (1) frequency response data, (2) echo return loss enhancement measures, (3) voice direction measures; (4) arbitration statistics; and/or (5) speech spectral data. In example implementations, the noise classifier may analyze the sound metadata in the buffer to classify noise in the detected sound S_{D}.

As noted above, one classification of sound may be background speech, such as speech indicative of far-field speech and/or speech indicative of a conversation not involving the NMD 703. The noise classifier may output a signal and/or set a state variable indicating that background speech is present in the environment. The presence of voice activity (i.e., speech) in the pre-roll portion of the voice input 755 indicates that the voice input 755 might not be directed to the NMD 703, but instead be conversational speech within the environment. For instance, a household member might speak something like “our kids should have a play date soon” without intending to direct the command keyword “play” to the NMD 703.

Further, when the noise classifier indicates that background speech is present is present in the environment, this condition may disable the mini-SLU pipeline 770 and/or the local voice input pipeline 770. In some implementations, the condition of background speech being absent in the environment (perhaps as indicated by a state variable set by the noise classifier) is configured as one of the command conditions for the command keywords.

Further, the noise classifier may determine whether background speech is present in the environment based on one or more metrics. For example, the noise classifier may determine a count of frames in the pre-roll portion of the voice input 755 that indicate background speech. If this count exceeds a threshold percentage or number of frames, the noise classifier may be configured to output the signal or set the state variable indicating that background speech is present in the environment. Other metrics may be used as well in addition to, or as an alternative to, such a count.

Referring still to FIG. 7C, in example embodiments, the voice back end including the wake-word engines 758, the local voice input pipeline 760, and the mini-SLU pipeline 770 may take a variety of forms. For instance, these components may take the form of one or more modules that are stored in memory of the NMD 703 (e.g., the memory 713 of FIG. 7A). As another example, these components may take the form of a general-purposes or special-purpose processor, or modules thereof. In this respect, the wake-word engines 758, the local voice input pipeline 760, and the mini-SLU pipeline 770 may be part of the same physical component of the NMD 703 or each of the wake-word engines 758, the local voice input pipeline 760, and the mini-SLU pipeline 770 may take the form of a dedicated component. Other possibilities also exist.

### IV. Example Local Voice Control Scenarios

As noted above, the NMD 703 may perform local (“offline”) voice input processing. As noted above, the NMD 703 may perform local voice input processing using a local voice input engine 760 or a mini-SLU pipeline 770. FIGS. 8A, 8B, 8C, and 8D present example local voice input processing sequences.

FIG. 8A shows an example sequence 881 of the NMD 703 processing an utterance by a user 123a. At 881a, the user 123a speaks an utterance “party time” corresponding to a custom keyword. This custom keyword may have been pre-configured by the user 123a to perform a command or a set of commands. For instance, the user configures the “party time” custom keyword to group a set of playback devices, such as the playback devices in the Kitchen 101h, the Living Room 101f, and the Dining Room 101g (FIG. 1A), and to start playing back a particular playlist on the grouped devices.

At 881b, the microphones capture this utterance as a voice input 755a and provide detected sound, S_{D}, to the voice front end 757. At 881c, the voice front end 757 processes the sound data and provides the sound-data stream S_{DS} to the parallel voice processing pipelines, including the mini-SLU pipeline 770. The other parallel voice input processing pipelines are shown in FIG. 7C.

At 881d, the hybrid keyword detector 771 of the mini-SLU pipeline 770 performs keyword spotting on the sound-data stream S_{DS} using the neural architecture 775. The output layer 777 of the mini-SLU pipeline 770 generates confidence scores predicting whether each trained keyword is in the sound-data stream S_{DS}. Recall that the weights of the output layer 777 that produce the confidence scores are not necessarily trained directly (and typically not trained directly for custom keywords), but rather predicted by the keyword encoder 778 (FIG. 7D).

Here, the hybrid keyword detector 771 spots the custom keyword “party time” and generates a keyword detection event. In this case, the confidence score for the keyword “party time” is 0.642. In this example, the threshold is 0.5, so the hybrid keyword detector 771 considers the voice input 755a to include this keyword. The confidence scores for the other keywords trained on the neural architecture 775 are not shown. In this example, they would be near zero indicating that it's unlikely that these other keywords appear in the sound-data stream S_{DS}.

At 881e, the speaker ID engine 773 determines whether the voice input 755a matches a pre-determined speaker profile. In this example, the NMD 703 has stored two pre-determined speaker profiles corresponding to the user 123a and a user 123b. Here, the speaker ID engine 773 determines that the voice input matches the pre-determined speaker profile corresponding to the user 123a.

Based on generating the keyword event and determining that the voice input 755a includes sound data matching one of the predetermined speaker profiles, the NMD 703 performs one or more commands associated with the keyword. In this case, the NMD 703 instructs the playback devices 102 in the Kitchen 101h, the Living Room 101f, and the Dining Room 101g to form a synchrony group and to start playing back a particular playlist.

FIG. 8B shows an example sequence 882 of the NMD 703 processing an utterance by a user 123b. At 882a, the user 123b speaks an utterance “turn on patio lights,” which includes a pre-loaded keyword (“turn on”) and a custom keyword “patio lights”. This custom keyword may have been pre-configured by the user 123a to refer to a smart illumination device.

At 882b, the microphones capture this utterance as a voice input 755b and provide detected sound, S_{D}, to the voice front end 757. At 882c, the voice front end 757 processes the sound data and provides the sound-data stream S_{DS} to the parallel voice processing pipelines, including the mini-SLU pipeline 770. The other parallel voice input processing pipelines are shown in FIG. 7C.

At 882d, the hybrid keyword detector 771 of the mini-SLU pipeline 770 performs keyword spotting on the sound-data stream S_{DS} using the neural architecture 775. The output layer 777 of the mini-SLU pipeline 770 generates confidence scores predicting whether each trained keyword is in the sound-data stream S_{DS}. Recall that the weights of the output layer 777 that produce the confidence scores for pre-loaded keywords may be trained with keyword-specific training data, which may result in the hybrid keyword detector 771 having relatively greater confidence in detecting pre-loaded keywords.

Here, the hybrid keyword detector 771 spots the pre-loaded keyword “turn on” and generates a keyword detection event. In this case, the confidence score for the keyword “turn on” is 0.834 and the confidence score for the keyword “patio lights” is 0.417. As noted above, the threshold is 0.5, so the hybrid keyword detector 771 considers the voice input 755b to include the keyword “turn on” but has not predicted the presence of the keyword “patio lights” with sufficient confidence.

However, in this example, the hybrid keyword detector 771 spotted the (“low-confidence”) custom keyword “patio lights” in the voice input 755b with the pre-loaded (“high-confidence”). Accordingly, the mini-SLU pipeline 770 can be more confident that the patio lights keyword is intended as a voice input. As such, at 882e, the mini-SLU pipeline 770 adjusts the confidence score upward (by an exemplary 0.1 adjustment). This gives the custom keyword “patio lights” an adjusted confidence score of 0.517, which exceeds the threshold.

At 882f, the speaker ID engine 773 determines whether the voice input 755b matches a pre-determined speaker profile. As noted above, the NMD 703 has stored two pre-determined speaker profiles corresponding to the user 123a and a user 123b. Here, the speaker ID engine 773 determines that the voice input matches the pre-determined speaker profile corresponding to the user 123b.

Based on generating the keyword event and determining that the voice input 755b includes sound data matching a predetermined speaker profile, the NMD 703 performs one or more commands associated with the keyword. In this case, the NMD 703 instructs the smart illumination device with the name “patio lights” to turn on.

FIG. 8C shows an example sequence 883 of the NMD 703 processing an utterance by a user 123c. At 883a, the user 123c speaks an utterance “pause” corresponding to a pre-loaded keyword.

At 883b, the microphones capture this utterance as a voice input 755c and provide detected sound, S_{D}, to the voice front end 757. At 883c, the voice front end 757 processes the sound data and provides the sound-data stream S_{DS} to the parallel voice processing pipelines, including the mini-SLU pipeline 770. The other parallel voice input processing pipelines are shown in FIG. 7C.

At 883d, the hybrid keyword detector 771 of the mini-SLU pipeline 770 performs keyword spotting on the sound-data stream S_{DS} using the neural architecture 775. The output layer 777 of the mini-SLU pipeline 770 generates confidence scores predicting whether each trained keyword is in the sound-data stream S_{DS}.

Here, the hybrid keyword detector 771 spots the pre-loaded keyword “pause” and generates a keyword detection event. In this case, the confidence score for the keyword “pause” is 0.891. In this example, the threshold is 0.5, so the hybrid keyword detector 771 considers the voice input 755c to include this keyword. The confidence scores for the other keywords trained on the neural architecture 775 are not shown. In this example, they would be near zero indicating that it's unlikely that these other keywords appear in the sound-data stream S_{DS}.

At 883e, the speaker ID engine 773 determines whether the voice input 755c matches a pre-determined speaker profile. In this example, the NMD 703 has stored two pre-determined speaker profiles corresponding to the user 123a and a user 123b. Here, the speaker ID engine 773 determines that the voice input spoken by the user 123c does not match the pre-determined speaker profile corresponding to the user 123a or the user 123c.

Based on generating the keyword event and determining that the voice input 755a includes sound data that does not match one of the predetermined speaker profiles, the NMD 703 forgoes performs commands associated with the keyword. That is, even though the hybrid keyword detector 771 spotted the keyword “pause” with high confidence exceeding the threshold, the NMD 703 does not perform the corresponding command.

In some implementations, the mini-SLU pipeline 770 may implement two or more thresholds corresponding to different confidence levels. For instance, a mini-SLU pipeline 770 may implement a first threshold (e.g., 0.5) and a second higher threshold (e.g., 0.85). If a confidence score for a keyword exceeds the first threshold but is lower than the second threshold, the mini-SLU pipeline 770 requires the voice input to match a pre-determined speaker profile. However, if the confidence score for a keyword exceeds the second threshold, the mini-SLU pipeline 770 performs the corresponding command without the voice input necessarily matching a pre-determined speaker profile. In other words, because of the high confidence score, the mini-SLU pipeline 770 may assume that the spotted keyword is not a false positive detection.

As noted above, some voice inputs may be processed by the local voice input pipeline 760. FIG. 8D shows an example sequence 884 of the NMD 703 processing an utterance by a user 123a using the local voice input pipeline 760. At 884a, the user 123a speaks an utterance “play Mitski in the Living Room.”

The mini-SLU pipeline 770 may concurrently process this voice input, but may not be able to derive the intent because the neural architecture 775 is not trained to detect certain keywords, such as the content name (the artist “Mitski”). As such, the mini-SLU pipeline 770 may automatically operate as a secondary processing pipeline to the mini-SLU pipeline 770. Alternatively, as noted above, some implementations of the NMD 703 might not include the mini-SLU pipeline 770 and so FIG. 8D may represent exemplary processing of a voice input by an implementation of the NMD 703 that does not include the mini-SLU pipeline 770.

At 884b, the microphones capture this utterance as a voice input 755d and provide detected sound, S_{D}, to the voice front end 757. At 884c, the voice front end 757 processes the sound data and provides the sound-data stream S_{DS} to the parallel voice processing pipelines, including the local voice input pipeline 760 and the mini-SLU pipeline 770 (not shown).

At 884d, the ASR 761 of the local voice input pipeline 760 performs automatic speech recognition on the sound-data stream S_{DS}. Then, at 884e, the local NLU 762 performs keyword spotting on the output of the sound-data stream S_{DS}. Similar to the hybrid keyword detector 771, the local NLU 762 generates confidence scores predicting certain keywords are present.

Here, the local NLU 762 spot the keywords “play” and generates a keyword detection event. In this case, the confidence score for the keyword “play” is 0.789. The confidence scores for “Mitski” keyword and the “living room” keyword are 0.313 and 0.598, respectively. In this example, the threshold is 0.5, so the local NLU 762 considers the voice input 755d to include the keyword “play” and “living room” but has not determined the presence of the keyword “Mitksi” with sufficient confidence.

However, in this example, the local NLU 762 spotted the relatively low-confidence keyword “Miski” in the voice input 755d with the relatively high-confidence keywords “play” and “living room.” Accordingly, at 884f, the local NLU 762 can be more confident that the “Mitski” keyword is intended as a voice input. The local NLU 762 adjusts the confidence score upward (by an exemplary 0.2 adjustment). This gives the keyword “Miski” an adjusted confidence score of 0.513, which exceeds the threshold.

Based on determining the intent of the voice input 884d, the NMD 703 performs one or more commands according to the determined intent. In this case, the NMD 703 starts the playback devices in the living room 101f (FIG. 1A) to start playing audio tracks by the artist Mitski from the default source (e.g., a default streaming audio service).

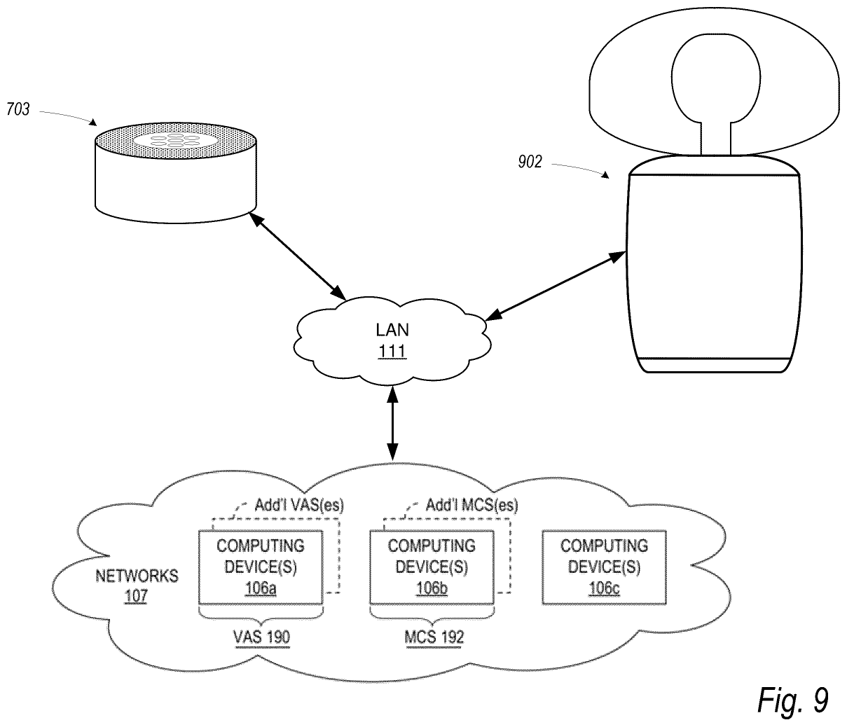

In example implementations, the NMD 703 is paired with one or more smart devices. FIG. 9 illustrates an example pairing arrangement between the NMD 703 and a smart device 902, which includes an integrated playback device and smart illumination device. By pairing the NMD 703 with the smart device(s), voice commands to control the smart device(s) may be directed to the NMD 703 to control the smart device(s) without necessarily including a keyword identifying the smart device(s) in the voice command. For instance, commands such as “play back Better Oblivion Community Center” and “turn on lights” are received by the NMD 703, but carried out on the smart device 809 without necessarily identifying the smart device 809 by name, room, zone, or the like. On the other hand, a user may still direct inputs to other smart devices in the MPS 100 by referencing the name, room, zone, group, area, etc. that the smart device is associated with.

Within examples, a user may configure the pairing arrangement using a graphical user interface or voice user interface. For instance, the user may use a GUI on a application of a control device 104 to configure the pairing arrangement. Alternatively, the user may speak a voice command such as “Please pair with the Ikea® lamp” or “Please pair with the Sonos® Play:1” to configure the pairing relationship. The NMD 703 may store data representing the pairing arrangement in one or more state variables, which may be referenced when identifying a device to carry out a voice command.

Further, in the exemplary pairing relationship of FIG. 9, the smart device 902 may play back audio responses to voice inputs. As noted above, the NMD 703 may, in some examples, exclude audio playback components typically present in a playback device (e.g., audio processing components 216, amplifiers 217, and/or speakers 218) or may include relatively less capable versions of these components. By pairing the NMD 703 to a playback device, the playback device may provide playback functions to complement the NMD, including playback of audio responses to voice inputs captured by the NMD 703 and playback of audio content initiated via voice command to the NMD 703.

For instance, the user may speak the voice input “Alexa, what is the weather,” which is captured by the microphones 722b (FIG. 7C) of the NMD 703. The NMD 703 transmits data representing this voice input to the servers 106a of the VAS 190. The servers 106a process this voice input and provide data representing a spoken response. In some implementations, the smart device 902 receives this data directly from the computing devices 106a of the VAS 190 via the networks 107 and the LAN 111. Alternatively, the NMD 703 may receive the data from the VAS 190, but send the data to the smart device 902. In either case, the playback device 902 plays back the spoken response.

As noted above, in some instances, voice input processing via the VAS 190 and voice input processing via the local voice input pipeline 760 and/or mini-SLU pipeline 770 may be concurrently enabled. In an example, a user may speak the voice input “Alexa, play ‘Hey Jude’ by the Beatles and turn on the Ikea lamps.” Here, “Alexa” is an example of a VAS wake word and “Ikea” is an example of a local keyword. Accordingly, such an input may generate both a VAS wake work event and one or more local events on the NMD 703.

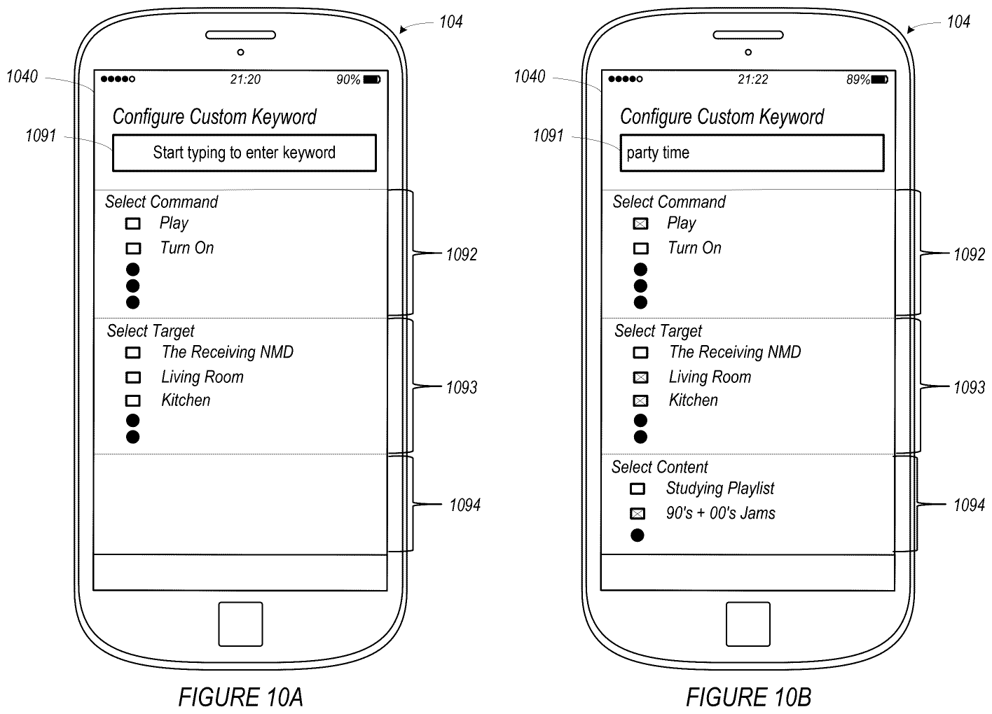

As described earlier, a user may configure a custom keyword using a graphical user interface. FIG. 10A shows an example controller interface 1040 displayed on a controller device 104 to facilitate configuring a custom keyword. The controller interface 1040 includes a first region 1191 configured to receive entry of text as a string. As discussed in connection with the neural architecture 775, the keyword encoder 778 may predict the weights used in the output layer 777 to detect custom keywords.

The controller interface 1040 further includes a second region 1092 with selectable controls corresponding to various commands. By way of example, the commands “play” and “turn on” are shown with respective selectable controls. Further example commands may be selectable as well. The second region 1092 may be scrollable to select additional commands.

The controller interface 1040 also includes a third region 1093 with selectable controls corresponding to various targets for the command selected in the second region 1092. To illustrate, selectable controls corresponding to the Living Room 101f and the Kitchen 101h (FIG. 1A) are shown, as well as a selectable control corresponding to the NMD that detects a voice input including the custom keyword. Further example targets may be selectable as well. The third region 1093 may be scrollable to select additional commands.

A fourth region 1094 may include selectable controls corresponding to the selected command. To illustrate, in FIG. 10B, a user has provided a custom keyword “party time” in the first region 1191 and selected the command “play” and the targets as the Living Room 101f and the Kitchen 101h. Then, the fourth region 1094 is populated with selectable controls corresponding to various playlists and other media items to select as content for the play command.

In some examples, the NMD 703 may configure the hybrid keyword detector 771 or the local NLU 672 to detect custom keywords that are not provided directly by the user, but nonetheless correspond to the user. The respective set of keywords that the hybrid keyword detector 771 or local NLU 672 are trained to spot are referred to collectively as the library of the NMD 703. Training the hybrid keyword detector 771 and/or the local NLU 672 may be referred to as populating the library. While these respective sets are referred to collectively, since the hybrid keyword detector 771 and the local NLU 672 are trained separately using different techniques, the sets of keywords that each component is trained to detect are not necessarily the same. Further, to maintain the small footprint of the mini-SLU pipeline 770, the hybrid keyword detector 771 will generally not be trained to detect as many keywords as the local NLU 672.

In a first aspect, the library may be customized to the devices that are within the household of the NMD (e.g., the household within the environment 101 (FIG. 1A)). For instance, the library may include keywords corresponding to the names of the devices within the household, such as the zone names of the playback devices 102 in the MPS 100. In a second aspect, the library may be customized to the users of the devices within the household. For example, the library may include keywords corresponding to names or other identifiers of a user's preferred playlists, artists, albums, and the like. Then, the user may refer to these names or identifiers in voice inputs.

Within example implementations, the NMD 703 may populate the library locally within the network 111 (FIG. 1B). As noted above, the NMD 703 may maintain or have access to state variables indicating the respective states of devices connected to the network 111 (e.g., the playback devices 104). These state variables may include names of the various devices. For instance, the kitchen 101h may include the playback device 101b, which are assigned the zone name “Kitchen.” The NMD 703 may read these names from the state variables and include them in the library by training the hybrid keyword detector 771 and/or the local NLU 672 to recognize them as keywords. The keyword entry for a given name may then be associated with the corresponding device in an associated parameter (e.g., by an identifier of the device, such as a MAC address or IP address). The NMD 703a can then use the parameters to customize control commands and direct the commands to a particular device.

In further examples, the NMD 703 may populate the library by discovering devices connected to the network 111. For instance, the NMD 703a may transmit discovery requests via the network 111 according to a protocol configured for device discovery, such as universal plug-and-play (UPnP) or zero-configuration networking. Devices on the network 111 may then respond to the discovery requests and exchange data representing the device names, identifiers, addresses and the like to facilitate communication and control via the network 111. The NMD 703 may read these names from the exchanged messages and include them in the library by training the hybrid keyword detector 771 and/or the local NLU 672 to recognize them as keywords.

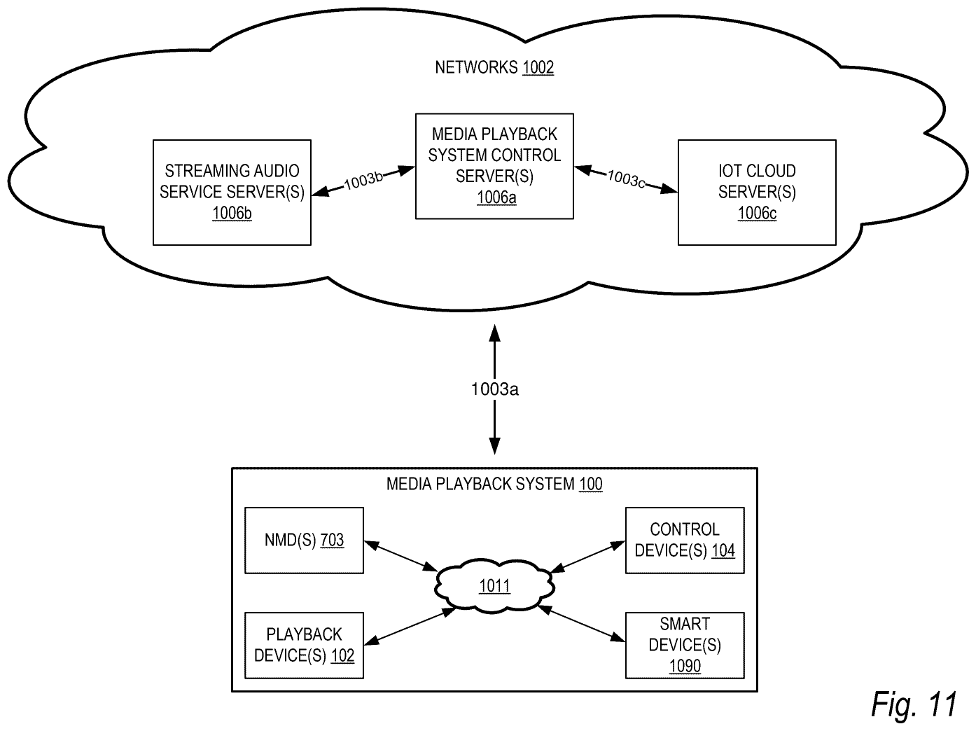

In further examples, the NMD 703 may populate the library using the cloud. To illustrate, FIG. 11 is a schematic diagram of the MPS 100 and a cloud network 1002. The cloud network 1002 includes cloud servers 1006, identified separately as media playback system control servers 1006a, streaming audio service servers 1006b, and IOT cloud servers 1006c. The streaming audio service servers 1006b may represent cloud servers of different streaming audio services. Similarly, the IOT cloud servers 1006c may represent cloud servers corresponding to different cloud services supporting smart devices 1090 in the MPS 100. Smart devices 1090 include smart illumination devices, smart thermostats, smart plugs, security cameras, doorbells, and the like.

Within examples, a user may link an account of the MPS 100 to an account of an IOT service. For instance, an IOT manufacturer (such as IKEA®) may operate a cloud-based IOT service to facilitate cloud-based control of their IOT products using smartphone app, website portal, and the like. In connection with such linking, the hybrid keyword detector 771 and/or the local NLU 672 may be trained with keywords associated with the cloud-based service and the IOT devices. For instance, the local NLU 672 may be trained with a nonce keyword (e.g., “Hey Ikea”). Further, the hybrid keyword detector 771 and/or the local NLU 672 may be trained to detected names of various IOT devices, keyword commands for controlling the IOT devices, and keywords corresponding to parameters for the commands.

One or more communication links 1003a, 1003b, and 1003c (referred to hereinafter as “the links 1003”) communicatively couple the MPS 100 and the cloud servers 1006. The links 1003 can include one or more wired networks and one or more wireless networks (e.g., the Internet). Further, similar to the network 111 (FIG. 1B), a network 1011 communicatively couples the links 1003 and at least a portion of the devices (e.g., one or more of the playback devices 102, NMDs 103, control devices 104, and/or smart devices 1090) of the MPS 100.

In some implementations, the media playback system control servers 1006a facilitate populating the library. In an example, the media playback system control servers 1006a may receive data representing a request to populate the library from the NMD 703a. Based on this request, the media playback system control servers 1006a may communicate with the streaming audio service servers 1006b and/or IOT cloud servers 1006c to obtain keywords specific to the user.

In some examples, the media playback system control servers 1006a may utilize user accounts and/or user profiles in obtaining keywords specific to the user. As noted above, a user of the MPS 100 may set-up a user profile to define settings and other information within the MPS 100. The user profile may then in turn be registered with user accounts of one or more streaming audio services to facilitate streaming audio from such services to the playback devices 102 of the MPS 100.

Through use of these registered streaming audio services, the streaming audio service servers 1006b may collect data indicating a user's saved or preferred playlists, artists, albums, tracks, and the like, either via usage history or via user input (e.g., via a user input designating a media item as saved or a favorite). This data may be stored in a database on the streaming audio service servers 1006b to facilitate providing certain features of the streaming audio service to the user, such as custom playlists, recommendations, and similar features. Under appropriate conditions (e.g., after receiving user permission), the streaming audio service servers 1006b may share this data with the media playback system control servers 1006a over the links 1003b.

Accordingly, within examples, the media playback system control servers 1006a may maintain or have access to data indicating a user's saved or preferred playlists, artists, albums, tracks, genres, and the like. If a user has registered their user profile with multiple streaming audio services, the saved data may include saved playlists, artists, albums, tracks, and the like from two or more streaming audio services. Further, the media playback system control servers 1006a may develop a more complete understanding of the user's preferred playlists, artists, albums, tracks, and the like by aggregating data from the two or more streaming audio services, as compared with a streaming audio service that only has access to data generated through use of its own service.

Moreover, in some implementations, in addition to the data shared from the streaming audio service servers 1006b, the media playback system control servers 1006a may collect usage data from the MPS 100 over the links 1003a, after receiving user permission. This may include data indicating a user's saved or preferred media items on a zone basis. Different types of music may be preferred in different rooms. For instance, a user may prefer upbeat music in the Kitchen 101h and more mellow music to assist with focus in the Office 101e.

Using the data indicating a user's saved or preferred playlists, artists, albums, tracks, and the like, the media playback system control servers 1006a may identify names of playlists, artists, albums, tracks, and the like that the user is likely to refer to when providing playback commands to the NMDs 703 via voice input. Data representing these names can then be transmitted via the links 1003a and the network 1004 to the NMDs 703 and then added to the library as keywords. For instance, the media playback system control servers 1006a may send instructions to the NMD 703 to train the hybrid keyword detector 771 and/or the local NLU 672 to spot certain names as keywords. Alternatively, the NMD 703 (or another device of the MPS 100) may identify names of playlists, artists, albums, tracks, and the like that the user is likely to refer to when providing playback commands to the NMD 703 via voice input and then train the hybrid keyword detector 771 and/or the local NLU 672 to spot these names.

Due to such customization, similar voice inputs may result in different operations being performed when the voice input is processed locally as compared with processing by a VAS. For instance, a first voice input of “Alexa, play me my favorites in the Office” may trigger a VAS wake-word event, as it includes a VAS wake word (“Alexa”). A second voice input of “Play me my favorites in the Office” may trigger a command keyword, as it includes a command keyword (“play”). Accordingly, the first voice input is sent by the NMD 703 to the VAS, while the second voice input is processed locally.

While these voice inputs are nearly identical, they may cause different operations. In particular, the VAS may, to the best of its ability, determine a first playlist of audio tracks to add to a queue of the playback device 102f in the office 101e. Similarly, the local NLU 776 may recognize keywords “favorites” and “kitchen” in the second voice input. Accordingly, the NMD 703 performs the voice command of “play” with parameters of <favorites playlist> and <kitchen 101h zone>, which causes a second playlist of audio tracks to be added to the queue of the playback device 102f in the office 101e. However, the second playlist of audio tracks may include a more complete and/or more accurate collection of the user's favorite audio tracks, as the second playlist of audio tracks may draw on data indicating a user's saved or preferred playlists, artists, albums, and tracks from multiple streaming audio services, and/or the usage data collected by the media playback system control servers 1006a. In contrast, the VAS may draw on its relatively limited conception of the user's saved or preferred playlists, artists, albums, and tracks when determining the first playlist.

A household may include multiple users. Two or more users may configure their own respective user profiles with the MPS 100. Each user profile may have its own user accounts of one or more streaming audio services associated with the respective user profile. Further, the media playback system control servers 1006a may maintain or have access to data indicating each user's saved or preferred playlists, artists, albums, tracks, genres, and the like, which may be associated with the user profile of that user.

In various examples, names corresponding to user profiles may be populated in the library. This may facilitate referring to a particular user's saved or preferred playlists, artists, albums, tracks, or genres. For instance, when a voice input of “Play Anne's favorites on the patio” is processed by the local NLU 762, the local NLU 762 may determine that “Anne” matches a stored keyword corresponding to a particular user. Then, when performing the playback command corresponding to that voice input, the NMD 703 adds a playlist of that particular user's favorite audio tracks to the queue of the playback device 102c in the patio 101i.

In some cases, a voice input might not include a keyword corresponding to a particular user, but multiple user profiles are configured with the MPS 100. In some cases, the NMD 703a may determine the user profile to use in performing a command using voice recognition, such as the speaker ID engine 773. Although shown as part of the mini-SLU pipeline 770 by way of example, the speaker ID engine 773 may be implemented in a manner accessible to the local voice input engine 770. Alternatively, the NMD 703a may default to a certain user profile. Further, the NMD 703 may use preferences from the multiple user profiles when performing a command corresponding to a voice input that did not identify a particular user profile. For instance, the NMD 703 may determine a favorites playlist including preferred or saved audio tracks from each user profile registered with the MPS 100.

The IOT cloud servers 1006c may be configured to provide supporting cloud services to the smart devices 1090. The smart devices 1090 may include various “smart” internet-connected devices, such as lights, thermostats, cameras, security systems, appliances, and the like. For instance, an IOT cloud server 1006c may provide a cloud service supporting a smart thermostat, which allows a user to control the smart thermostat over the internet via a smartphone app or website.

Accordingly, within examples, the IOT cloud servers 1006c may maintain or have access to data associated with a user's smart devices 1090, such as device names, settings, and configuration. Under appropriate conditions (e.g., after receiving user permission), the IOT cloud servers 1006c may share this data with the media playback system control servers 1006a and/or the NMD 703 via the links 1003c. For instance, the IOT cloud servers 1006c that provide the smart thermostat cloud service may provide data representing such keywords to the NMD 703, which facilitates populating the library with keywords corresponding to the temperature.

Yet further, in some cases, the IOT cloud servers 1006c may also provide keywords specific to control of their corresponding smart devices 1090. For instance, the IOT cloud server 1006c that provides the cloud service supporting the smart thermostat may provide a set of keywords corresponding to voice control of a thermostat, such as “temperature,” “warmer,” or “cooler,” among other examples. Data representing such keywords may be sent to the NMD 703 over the links 1003 and the network 1004 from the IOT cloud servers 1006c.

As noted above, some households may include more than NMD 703. In example implementations, two or more NMDs 703 may synchronize or otherwise update their libraries. For instance, a first NMD 703a and a second NMD 703b may share data representing their respective libraries, possibly using a network (e.g., the network 904). Such sharing may facilitate the NMDs 703a being able to respond to voice input similarly, among other possible benefits.

In some embodiments, one or more of the components described above can operate in conjunction with the microphones 722 to detect and store a user's pre-determined speaker profile, which may be associated with a user account of the MPS 100. In some embodiments, speaker profiles may be stored as and/or compared to variables stored in a set of command information or data table. The voice profile may include aspects of the tone or frequency of a user's voice and/or other unique aspects of the user, such as those described in previously-referenced U.S. patent application Ser. No. 15/438,749.

In some embodiments, one or more of the components described above can operate in conjunction with the microphones 722 to determine the location of a user in the home environment and/or relative to a location of one or more of the NMDs 103. Techniques for determining the location or proximity of a user may include one or more techniques disclosed in previously-referenced U.S. patent application Ser. No. 15/438,749, U.S. Pat. No. 9,084,058 filed Dec. 29, 2011, and titled “Sound Field Calibration Using Listener Localization,” and U.S. Pat. No. 8,965,033 filed Aug. 31, 2012, and titled “Acoustic Optimization.” Each of these applications is herein incorporated by reference in its entirety.

### V. First Example Local Voice Control Techniques

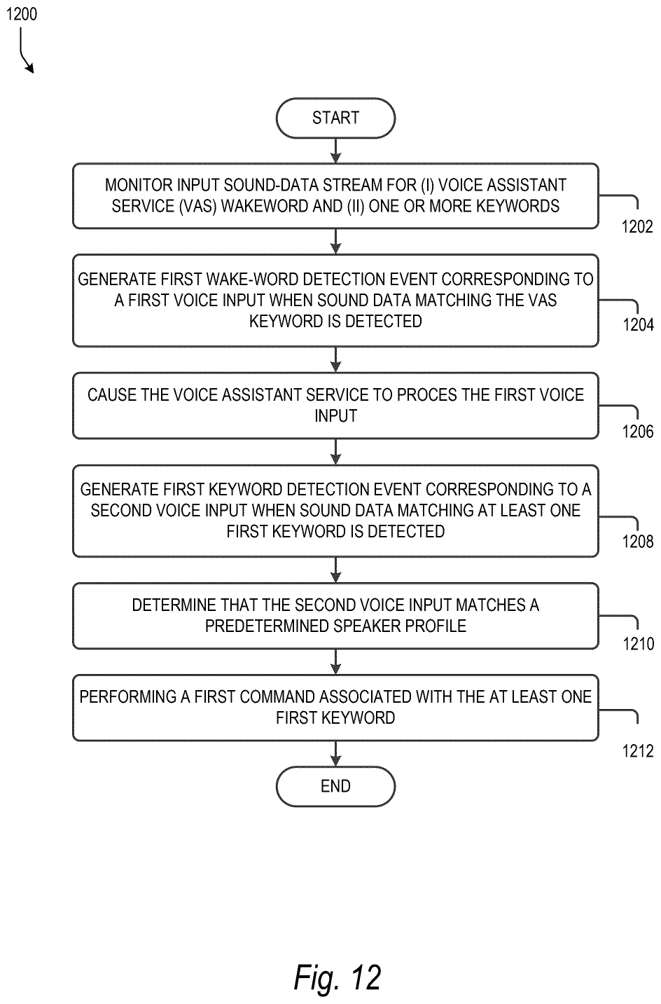

FIG. 12 is a flow diagram showing an example method 1200 to perform local voice control. The method 1200 may be performed by a networked microphone device, such as the NMD 703 (FIG. 7A). Alternatively, the method 1200 may be performed by any suitable device or by a system of devices, such as the playback devices 102, NMDs 103, control devices 104, computing devices 105, computing devices 106, and/or NMD 703.

At block 1202, the method 1200 includes monitoring an input sound-data stream representing sound detected by the one or more microphones for (i) a voice assistant service (VAS) wake word and (ii) one or more keywords. For instance, the NMD 703 may monitor the input sound-data stream S_{DS} via the wake-word engine 758a for a wake word associated with a voice assistant service (FIG. 7C). Further, the hybrid keyword detector 771 of the mini-SLU pipeline 770 may concurrently monitor the sound-data stream S_{DS} for one or more keywords (FIG. 7C). Additionally or alternatively, the wake-word engine 758b may concurrently monitor the sound-data stream S_{DS} for one or more local keywords (FIG. 7C).

At block 1204, the method 1200 includes generating a first wake-word detection event corresponding to a first voice input when sound data matching the VAS keyword is detected. For, instance, the wake-word engine 758a may generate a VAS wake-word event corresponding to a first voice input when the wake-word engine 758a detects sound data matching the VAS wake word in the sound-data stream S_{DS} (FIG. 7C).

At block 1206, the method 1200 includes causing the voice assistant service to process the first voice input. For instance, based on generating VAS wake-word event corresponding to the first voice input, the NMD 703 may cause the voice extractor 759 to receive and format (e.g., packetize) the sound-data stream S_{DS} into messages and then transmit or stream these messages, M_{V}, to a remote VAS via the network interface 724 (FIG. 7C). The VAS receives these messages, M_{V}, processes the voice input (e.g., performs spoken language understanding to determine an intent of the voice input), and then transmits back one or more instructions to perform a command according to the determined intent.

At block 1208, the method 1200 includes generating a first keyword detection event corresponding to a second voice input when sound data matching at least one first keyword is detected. For example, the hybrid keyword detector 771 of the mini-SLU pipeline 770 may generate a keyword detection event corresponding to a second voice input when at least one first keyword is spotted in the sound-data stream S_{DS} (FIG. 7C). The hybrid keyword detector 771 may detect keywords using the neural architecture 775 (FIG. 7D), among other examples.

At block 1210, the method 1200 includes determining that the second voice input matches a particular predetermined speaker profile of one or more predetermined speaker profiles. For instance, the speaker ID engine 773 may determine whether the portion of the sound-data stream S_{DS} corresponding to second voice input matches a particular predetermined speaker profile of one or more predetermined speaker profiles (FIG. 7C). Further exemplary operation of the speaker ID engine 773 is described in connection with FIGS. 8A, 8B, and 8C.

Within examples, the method 1200 may involve monitoring the input sound-data stream for voice data that match the one or more predetermined speaker profiles. For example, the speaker ID engine 773 may monitor the sound-data stream S_{DS} for voice data that match the one or more predetermined speaker profiles. In such examples, determining that the second voice input matches the particular predetermined speaker profile may involve determining that a portion of the input sound-data stream corresponding to the second voice input includes particular voice data matching the particular predetermined speaker profile. In some examples, the speaker ID engine 773 may monitor the input sound-data stream for voice data concurrently with the hybrid keyword detector 771 monitoring the input sound-data stream for the one or more keywords.

At block 1212, the method 1200 includes performing a particular command associated with the at least one first keyword. For instance, when the at least one first keyword is associated with a particular playback command, the NMD 703 may perform the particular playback command by instructing one or more playback devices to perform the particular playback command. Other examples are possible as well.

In some cases, a voice input does not match any speaker profile of one or more predetermined speaker profiles. For example, the method 1200 may further involve generating a second keyword detection event corresponding to a third voice input when the one or more keyword engines detect sound data matching at least one second keyword of the one or more keywords. For instance, the hybrid keyword detector 771 of the mini-SLU pipeline 770 may generate a second keyword detection event corresponding to a third voice input when the hybrid keyword detector 771 detects sound data matching at least one second keyword of the one or more keywords. The speaker ID engine 773 may determine that the third voice input does not match any of the one or more predetermined speaker profiles. Based on (i) generating the second keyword detection event and (ii) determining that the third voice input does not match any of the one or more predetermined speaker profiles, the method 1200 may involve foregoing processing of the third voice input.

In other cases, a voice input may include sound data matching both a VAS wake word and at least one keyword. In some implementations, the NMD 703 processes the voice input using the VAS in such circumstances. For instance, the method 1200 may involve generating a second wake-word detection event corresponding to a fourth voice input when the one or more keyword engines detect both (i) sound data matching the wake word in the input sound-data stream and (ii) sound data matching at least one keyword of the one or more keywords. Based on generating the second wake-word detection event, the method 1200 involves causing the voice assistant service to process the fourth voice input.

Within examples, the method 1200 further involves receiving data representing a command to associate the at least one first keyword of the one or more keywords with the particular predetermined speaker profile. As described above in connection with FIG. 7C, this association may indicate greater confidence in detecting keywords in a voice input, since the speaker of the keyword is the same user that configured the custom keyword. Based on receiving the data representing the command, the method 1200 involves storing, in the data storage, an association between the at least one first keyword and the particular predetermined speaker profile. In such cases, performing the particular command associated with the at least one first keyword is further may be further based on determining that there is a stored association between the at least one first keyword and the particular predetermined speaker profile in the data storage.

In some implementations, the method 1200 involves updating at least one of the one or more keyword engines with parameters corresponding to the particular predetermined speaker profile based on determining that the second voice input matches the particular predetermined speaker profile. That is, the weights of the output layer 777 may be adjusted to better train the neural architecture 775 to detect the keyword as spoken by the particular predetermined speaker profile. In other words, the recorded keyword as spoken by a particular user acts as keyword-specific training data to retrain the neural architecture 775.

In some examples, the method 1200 further involves receiving string data representing one or more custom keywords corresponding to the particular predetermined speaker profile and training the neural network to detect the one or more custom keywords based on the string data. For example, the NMD 703 may receive string data from the control device 104, which was received via graphical user interface such as the controller interface 1040 (FIG. 10A). Other examples are possible as well.

### VI. Second Example Local Voice Control Techniques

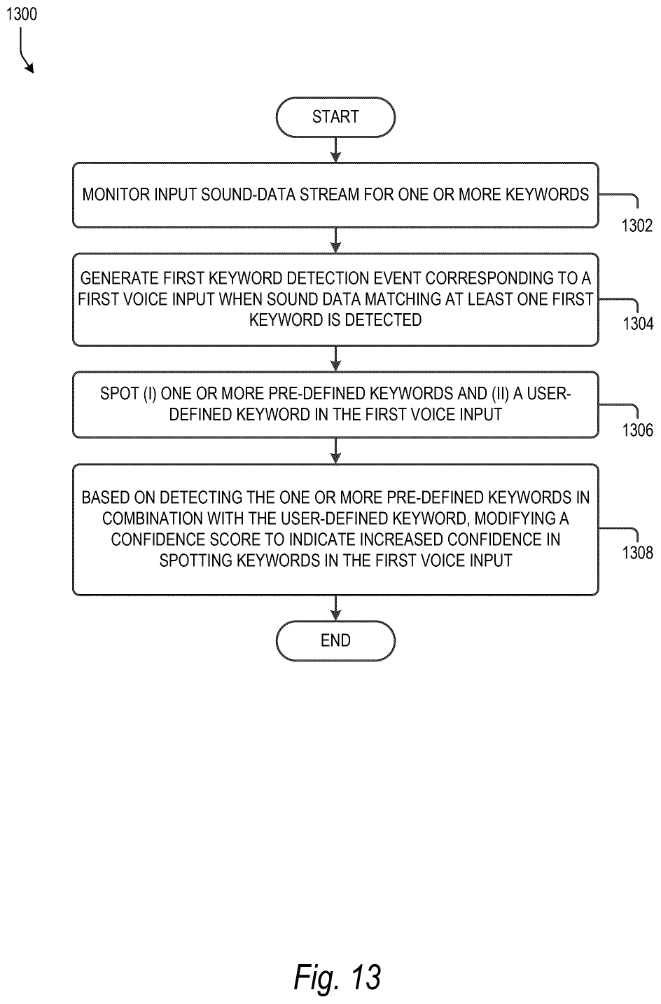

FIG. 13 is a flow diagram showing an example method 1300 to perform local voice control. The method 1300 may be performed by a networked microphone device, such as the NMD 703 (FIG. 7A). Alternatively, the method 1300 may be performed by any suitable device or by a system of devices, such as the playback devices 102, NMDs 103, control devices 104, computing devices 105, computing devices 106, and/or NMD 703.

At block 1302, the method 1300 includes monitoring an input sound-data stream representing sound detected by the one or more microphones for one or more keywords. For instance, the wake-word engine 758b of the NMD 703 may monitor the sound-data stream S_{DS} for one or more local keywords (FIG. 7C). As another example, the hybrid keyword detector 771 of the mini-SLU pipeline 770 may monitor the sound-data stream S_{DS} for one or more keywords (FIG. 7C). Such monitoring may occur concurrently with the NMD 703 monitoring the sound-data stream S_{DS} via the wake-word engine 758a for a wake word associated with a voice assistant service (FIG. 7C).

At block 1304, the method 1300 includes generating a first keyword detection event corresponding to a second voice input when sound data matching at least one first keyword is detected in the sound-data stream S_{DS}. For example, the wake-word engine 758b may generate a local keyword event when detecting a first keyword in the sound-data stream S_{DS} (FIG. 7C). As another example, the hybrid keyword detector 771 of the mini-SLU pipeline 770 may generate a keyword detection event corresponding to a second voice input when at least one first keyword is spotted in the sound-data stream S_{DS} (FIG. 7C).

At block 1306, the method 1300 includes spotting (i) one or more pre-defined keywords and (ii) a user-defined keyword in the first voice input. For instance, the local voice input pipeline 760 may perform ASR and NLU on the first voice input using the ASR 761 and local NLU 762. In performing ARS and NLU, the local voice input pipeline 760 may detect (i) one or more pre-defined keywords and (ii) a user-defined keyword in the first voice input, as illustrated in the exemplary processing sequence 884 (FIG. 8D). As another example, the mini-SLU pipeline 770 may perform keyword spotting on the first voice input using the hybrid keyword detector 771. Such keyword spotting may result in spotting (i) one or more pre-defined keywords and (ii) a user-defined keyword in the first voice input, as illustrated in the exemplary processing sequence 882 of FIG. 8B.

When keyword spotting, the NMD 703 may determine one or more confidence metrics indicating confidence in recognizing keywords from the keyword library in the first voice input. For instance, the NMD 703 may determine a first sub-metric indicating confidence in recognizing the particular user-defined keyword in the first voice input and one or more second sub-metrics indicating confidence in recognizing the one or more pre-loaded keywords from the keyword library in the first voice input. Exemplary determination of such sub-metrics are illustrated with the confidence scores for the individual keywords shown in the processing sequences 882 and 884 of FIGS. 8B and 8D, respectively.

At block 1308, the method 1300 includes modifying a confidence metric to indicate increased confidence in detecting keywords from the keyword library in the first voice input. For instance, based detecting the one or more pre-defined keywords in combination with the first user-defined keyword, the local voice input pipeline 760 may increase a confidence score for the user-defined keyword, as illustrated in the exemplary processing sequence 884 (FIG. 8D). As another example, the mini-SLU pipeline 770 may increase a confidence score for the user-defined keyword, as illustrated in the exemplary processing sequence 882 (FIG. 8B).

In some cases, the NMD 703 may determine a confidence score for a voice input as a whole, perhaps based on confidence scores in spotting individual keywords. In such cases, modifying the confidence metric may involve modifying the confidence score for the voice input as a whole. Alternatively, as noted above, modifying the confidence metric may involve modifying the confidence scores for spotting individual keywords, which results in an increased confidence score for the voice input as a whole.

In some implementations, the method 1300 further includes determining that the modified confidence metric exceeds a confidence threshold. For instance, as discussed with respect to the exemplary processing sequences 882 and 884, a confidence threshold may be set at 0.5. Based on (i) generating the first keyword detection event and (ii) determining that the modified confidence metric exceeds the confidence threshold, the method 1300 may involve performing a particular playback command corresponding to the detected keywords in the first voice input.

In some instances, the method 1300 may further involve detecting a second voice input that does not include any pre-defined keywords. In such examples, the method 1300 may further involve generating a second keyword detection event corresponding to a second voice input when the one or more keyword engines detect sound data matching a second keyword in the input sound-data stream and spotting a second user-defined keyword in the second voice input. The method may further involve determining a confidence metric indicating confidence in recognizing keywords in the second voice input, and based on not detecting pre-defined keywords in the second voice input, foregoing modifying the confidence metric to indicate increased confidence in detecting keywords in the second voice input.

Further, in some cases, a confidence score might not exceed a threshold. To illustrate, in some examples, the method 1300 may involve determining that the confidence metric indicating confidence in recognizing keywords in the second voice input does not meet a confidence threshold. Then, based on (i) generating the second keyword detection event and (ii) determining that the confidence metric indicating confidence in recognizing keywords from the keyword library in the second voice input does not meet a confidence threshold, the method 1300 involves foregoing performing a particular playback command corresponding to the detected keywords in the second voice input.

### Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

Example 1: A method to be performed by a device including a network interface, one or more microphones, one or more processors, at least one speaker, and data storage having stored therein instructions executable by the one or more processors. The method includes monitoring, via one or more keyword engines, an input sound-data stream representing sound detected by the one or more microphones for (i) a wake word associated with a voice assistant service and (ii) one or more keywords, wherein the one or more keywords are different than the wake word; generating a first wake-word detection event corresponding to a first voice input when the one or more keyword engines detect sound data matching the wake word in the input sound-data stream; based on generating the first wake-word detection event, causing the voice assistant service to process the first voice input; generating a first keyword detection event corresponding to a second voice input when the one or more keyword engines detect sound data matching at least one first keyword of the one or more keywords, determining that the second voice input matches a particular predetermined speaker profile of one or more predetermined speaker profiles, and based on (i) generating the first keyword detection event and (ii) determining that the second voice input includes sound data matching the particular predetermined speaker profile, performing a particular playback command associated with the at least one first keyword.

Example 2: The method of Example 1, wherein the method further comprises: generating a second keyword detection event corresponding to a third voice input when the one or more keyword engines detect sound data matching at least one second keyword of the one or more keywords; determining that the third voice input does not match any of the one or more predetermined speaker profiles; and based on (i) generating the second keyword detection event and (ii) determining that the third voice input does not match any of the one or more predetermined speaker profiles, foregoing processing of the third voice input.

Example 3: The method of any of Examples 1 and 2, wherein the method further comprises: generating a second wake-word detection event corresponding to a fourth voice input when the one or more keyword engines detect both (i) sound data matching the wake word in the input sound-data stream and (ii) sound data matching at least one keyword of the one or more keywords; and based on generating the second wake-word detection event, causing the voice assistant service to process the fourth voice input.

Example 4: The method of any of Examples 1-3, wherein the one or more keyword engines comprise a wake word engine and a local keyword engine, and wherein monitoring the input sound-data stream via the one or more keyword engines comprises: monitoring, via the wake word engine, the input sound-data stream for the wake word associated with a voice assistant service; and monitoring, via the local keyword engine, the input sound-data stream for the one or more keywords.

Example 5: The method of any of Examples 1-4, wherein the method further comprises: receiving data representing a command to associate the at least one first keyword of the one or more keywords with the particular predetermined speaker profile; and based on receiving the data representing the command, storing, in the data storage, an association between the at least one first keyword and the particular predetermined speaker profile, wherein performing the particular playback command associated with the at least one first keyword is further based on determining that there is a stored association between the at least one first keyword and the particular predetermined speaker profile.

Example 6: The method of any of Examples 1-5, wherein the method further comprises: monitoring, via a speaker detection engine, the input sound-data stream for voice data that match the one or more predetermined speaker profiles, and wherein determining that the second voice input matches the particular predetermined speaker profile comprises determining, via a speaker detection engine, that a portion of the input sound-data stream corresponding to the second voice input includes particular voice data matching the particular predetermined speaker profile.

Example 7: The method of Examples 6, wherein monitoring, via the speaker detection engine, the input sound-data stream for voice data that matches the one or more predetermined speaker profiles comprises monitoring the input sound-data stream for voice data concurrently with monitoring the input sound-data stream for the one or more keywords.

Example 8: The method of any of Examples 1-7, wherein the method further comprises: based on determining that the second voice input matches the particular predetermined speaker profile, updating at least one of the one or more keyword engines with parameters corresponding to the particular predetermined speaker profile.

Example 8: The method of any of Examples 1-7, wherein the method further comprises: detecting, via a neural network, presence of sound data representing one or more keywords corresponding to the particular playback command in the second voice input, wherein the one or more keywords comprise the at least one first keyword.

Example 10: The method of Example 9, wherein the method further comprises: receiving string data representing one or more custom keywords corresponding to the particular predetermined speaker profile; and training the neural network to detect the one or more custom keywords based on the string data.

Example 11: A tangible, non-transitory, computer-readable medium having instructions stored thereon that are executable by one or more processors to cause a playback device to perform the method of any one of Examples 1-10.

Example 12: A playback device comprising at least one speaker, a network interface, one or more microphones, one or more processors, and a data storage having instructions stored thereon that are executable by the one or more processors to cause the playback device to perform the method of any of Examples 1-10.

Example 13: A method to be performed by a device including a network interface, one or more microphones, one or more processors, at least one speaker, and data storage having stored therein instructions executable by the one or more processors. The method includes monitoring, via one or more keyword engines, an input sound-data stream representing sound detected by the one or more microphones for one or more keywords from a keyword library, wherein the keyword library comprises pre-defined keywords and user-defined keywords; generating a first keyword detection event corresponding to a first voice input when the one or more keyword engines detect sound data matching a first keyword from the keyword library in the input sound-data stream; performing automatic speech recognition on the first voice input to detect keywords from the keyword library in the first voice input, wherein performing automatic speech recognition on the first voice input comprises: (i) detecting one or more pre-defined keywords from the keyword library in the first voice input; (ii) detecting a first user-defined keyword in the first voice input; and (iii) determining a confidence metric indicating confidence in recognizing keywords from the keyword library in the first voice input; and based on detecting the one or more pre-defined keywords in combination with the first user-defined keyword, modifying the confidence metric to indicate increased confidence in detecting keywords from the keyword library in the first voice input.

Example 14: The method of Example 13, wherein the method further comprises: determining that the modified confidence metric exceeds a confidence threshold; and based on (i) generating the first keyword detection event and (ii) determining that the modified confidence metric exceeds the confidence threshold, performing a particular playback command corresponding to the detected keywords in the first voice input.

Example 15: The method of any of Examples 13 and 14, wherein determining the confidence metric indicating confidence in recognizing keywords from the keyword library in the first voice input comprises: determining a first sub-metric indicating confidence in recognizing the particular user-defined keyword in the first voice input; determining one or more second sub-metrics indicating confidence in recognizing the one or more pre-loaded keywords from the keyword library in the first voice input, wherein the one or more second sub-metrics indicate higher confidence than the first sub-metric; and determining the confidence metric based on the first sub-metric and the one or more second sub-metrics.

Example 16: The method of Example 15, wherein modifying the confidence metric to indicate increased confidence in detecting keywords from the keyword library in the first voice input comprises: based on detecting the one or more pre-loaded keywords from the keyword library in the first voice input, modifying the first sub-metric to indicate increased confidence in recognizing the particular user-defined keyword in the first voice input.

Example 17: The method of any of Examples 13-16, wherein the method further comprises: generating a second keyword detection event corresponding to a second voice input when the one or more keyword engines detect sound data matching a second keyword from the keyword library in the input sound-data stream; performing automatic speech recognition on the second voice input to detect keywords from the keyword library in the second voice input, wherein performing automatic speech recognition on the second voice input comprises: (i) detecting a second user-defined keyword in the second voice input; and (ii) determining a confidence metric indicating confidence in recognizing keywords from the keyword library in the second voice input; and based on not detecting pre-defined keywords from the keyword library in the second voice input, foregoing modifying the confidence metric to indicate increased confidence in detecting keywords from the keyword library in the second voice input.

Example 18: The method of Example 17, wherein the method further comprises: determining that the confidence metric indicating confidence in recognizing keywords from the keyword library in the second voice input does not meet a confidence threshold; and based on (i) generating the second keyword detection event and (ii) determining that the confidence metric indicating confidence in recognizing keywords from the keyword library in the second voice input does not meet a confidence threshold, foregoing performing a particular playback command corresponding to the detected keywords in the second voice input.

Example 19: The method of any of Examples 13-18, wherein performing automatic speech recognition on the first voice input to detect keywords from the keyword library in the first voice input comprises: detecting, via a neural network, presence of sound data representing the user-defined keyword in a first portion of the first voice input; and detecting, via the neural network, presence of sound data representing the user-defined keyword in respective second portions of the first voice input, wherein the neural network was trained to detect the pre-defined keywords of the keyword library with additional sound data compared with the user-defined keywords of the keyword library.

Example 20: The method of any of Examples 13-19, 20, wherein the method further comprises: receiving string data representing one or more additional user-defined keywords; and training the neural network to detect the one or more additional user-defined keywords based on the string data.

Example 21: The method of any of Examples 13-20, wherein at least a portion of the pre-defined keywords correspond to respective playback commands, and wherein at least a portion of the user-defined keywords correspond to user-defined device names.

Example 22: A tangible, non-transitory, computer-readable medium having instructions stored thereon that are executable by one or more processors to cause a playback device to perform the method of any one of Examples 13-20.

Example 23: A playback device comprising at least one speaker, a network interface, one or more microphones, one or more processors, and a data storage having instructions stored thereon that are executable by the one or more processors to cause the playback device to perform the method of any of Examples 13-20.

1. A network microphone device (NMD) comprising:
a network interface;
one or more microphones;
at least one speaker;
at least one processor;
a housing carrying the network interface, the one or more microphones, the at least one speaker, and the at least one processor; and
at least one non-transitory computer-readable medium comprising program instructions that are executable by the at least one processor such that the NMD is configured to:
monitor, via one or more keyword engines, an input sound-data stream representing sound detected by the one or more microphones for one or more keywords associated with a local voice assistant implemented on the NMD, wherein detections of sound data matching the one or more keywords trigger generation of wake-word detection events that cause processing via the local voice assistant;
generate a first keyword detection event corresponding to a first voice input when the one or more keyword engines detect first sound data matching at least one first keyword of the one or more keywords;
determine that the first voice input matches a particular predetermined speaker profile of one or more predetermined speaker profiles such that a particular speaker of the first voice input is recognized;
based on (i) generation of the first keyword detection event and (ii) the determination that the first voice input includes sound data matching the particular predetermined speaker profile, process the first voice input via the local voice assistant, wherein the program instructions that are executable by the at least one processor such that the NMD is configured to process the first voice input via the local voice assistant comprise program instructions that are executable by the at least one processor such that the NMD is configured to determine a particular playback command associated with the at least one first keyword;
cause at least one playback device to perform the particular playback command associated with the at least one first keyword;
generate a second keyword detection event corresponding to a second voice input when the one or more keyword engines detect second sound data matching at least one second keyword of the one or more keywords;
determine that the second voice input does not match any of the one or more predetermined speaker profiles such that a speaker for the second voice input cannot be recognized; and
based on (i) generation of the second keyword detection event and (ii) the determination that the second voice input does not match any of the one or more predetermined speaker profiles, forgo processing of the second voice input via the local voice assistant.

2. The NMD of claim 1, wherein the at least one non-transitory computer-readable medium further comprises program instructions that are executable by the at least one processor such that the NMD is configured to:
monitor, via the one or more keyword engines, the input sound-data stream representing the sound detected by the one or more microphones for a wake word associated with a cloud-based voice assistant service implemented via one or more servers that are remote from the NMD concurrently with monitoring the input sound-data stream for the one or more keywords associated with the local voice assistant, wherein detections of sound data matching the wake word trigger generation of wake-word detection events that cause processing via the cloud-based voice assistant service;
generate a wake-word detection event corresponding to a third voice input when the one or more keyword engines detect third sound data matching the wake word in the input sound-data stream; and
based on generation of the wake-word detection event, cause, via the network interface, the cloud-based voice assistant service to process the third voice input.

3. The NMD of claim 2, wherein the program instructions that are executable by the at least one processor such that the NMD is configured to forgo processing of the second voice input via the local voice assistant comprise program instructions that are executable by the at least one processor such that the NMD is configured to:
cause, via the network interface, the cloud-based voice assistant service to process the second voice input.

4. The NMD of claim 1, wherein the program instructions that are executable by the at least one processor such that the NMD is configured to forgo processing of the second voice input via the local voice assistant comprise program instructions that are executable by the at least one processor such that the NMD is configured to:
forgo processing of the second voice input via either the local voice assistant or a cloud-based voice assistant.

5. The NMD of claim 1, wherein the at least one non-transitory computer-readable medium further comprises program instructions that are executable by the at least one processor such that the NMD is configured to:
receive data representing a command to associate the at least one first keyword of the one or more keywords with the particular predetermined speaker profile; and
based on receipt of the data representing the command, store, in data storage of the NMD, an association between the at least one first keyword and the particular predetermined speaker profile, wherein the program instructions that are executable by the at least one processor such that the NMD is configured to perform the particular playback command associated with the at least one first keyword comprise program instructions that are executable by the at least one processor such that the NMD is configured to:
perform the particular playback command when is a stored association between the at least one first keyword and the particular predetermined speaker profile, wherein performance of the particular playback command is foregone when there is not a stored association between the at least one first keyword and the particular predetermined speaker profile.

6. The NMD of claim 1, wherein the at least one non-transitory computer-readable medium further comprises program instructions that are executable by the at least one processor such that the NMD is configured to:
monitor, via a speaker detection engine, the input sound-data stream for voice data that match the one or more predetermined speaker profiles, wherein the program instructions that are executable by the at least one processor such that the NMD is configured to determine that the first voice input matches the particular predetermined speaker profile comprise program instructions that are executable by the at least one processor such that the NMD is configured to:
determine, via the speaker detection engine, that a portion of the input sound-data stream corresponding to the first voice input includes particular voice data matching the particular predetermined speaker profile such that the particular speaker of the first voice input is recognized.

7. The NMD of claim 6, wherein the program instructions that are executable by the at least one processor such that the NMD is configured to monitor the input sound-data stream for voice data that match the one or more predetermined speaker profiles comprise program instructions that are executable by the at least one processor such that the NMD is configured to:
monitor the input sound-data stream for voice data concurrently with monitoring the input sound-data stream for the one or more keywords.

8. The NMD of claim 1, wherein the at least one non-transitory computer-readable medium further comprises program instructions that are executable by the at least one processor such that the NMD is configured to:
based on the determination that the first voice input matches the particular predetermined speaker profile, update at least one of the one or more keyword engines with parameters corresponding to the particular predetermined speaker profile.

9. The NMD of claim 1, wherein the at least one non-transitory computer-readable medium further comprises program instructions that are executable by the at least one processor such that the NMD is configured to:
detect, via a neural network, presence of sound data representing the one or more keywords corresponding to the particular playback command in the first voice input, wherein the one or more keywords comprise the at least one first keyword.

10. The NMD of claim 1, wherein the program instructions that are executable by the at least one processor such that the NMD is configured to determine that the first voice input matches the particular predetermined speaker profile comprise program instructions that are executable by the at least one processor such that the NMD is configured to:
detect, via a neural network, presence of sound data matching the particular predetermined speaker profile such that the particular speaker of the first voice input is recognized.

11. The NMD of claim 1, wherein the at least one playback device comprises a first playback device and a second playback device connected via a local area network, wherein the first playback device comprises the NMD, and wherein the program instructions that are executable by the at least one processor such that the NMD is configured to cause at least one playback device to perform the particular playback command associated with the at least one first keyword comprise program instructions that are executable by the at least one processor such that the NMD is configured to:
send, via the network interface over the local area network, instructions that cause the second playback device to perform the particular playback command associated with the at least one first keyword.

12. A method to be performed by a network microphone device (NMD), the method comprising:
monitoring, via one or more keyword engines, an input sound-data stream representing sound detected by one or more microphones of the NMD for one or more keywords associated with a local voice assistant implemented on the NMD, wherein detections of sound data matching the one or more keywords trigger generation of wake-word detection events that cause processing via the local voice assistant;
generating a first keyword detection event corresponding to a first voice input when the one or more keyword engines detect first sound data matching at least one first keyword of the one or more keywords;
determining that the first voice input matches a particular predetermined speaker profile of one or more predetermined speaker profiles such that a particular speaker of the first voice input is recognized;
based on (i) generating the first keyword detection event and (ii) determining that the first voice input includes sound data matching the particular predetermined speaker profile, processing the first voice input via the local voice assistant, wherein processing the first voice input via the local voice assistant comprises determining a particular playback command associated with the at least one first keyword;
causing at least one playback device to perform the particular playback command associated with the at least one first keyword;
generating a second keyword detection event corresponding to a second voice input when the one or more keyword engines detect second sound data matching at least one second keyword of the one or more keywords;
determining that the second voice input does not match any of the one or more predetermined speaker profiles such that a speaker for the second voice input cannot be recognized; and
based on (i) generating the second keyword detection event and (ii) determining that the second voice input does not match any of the one or more predetermined speaker profiles, forgoing processing of the second voice input via the local voice assistant.

13. The method of claim 12, further comprising:
monitoring, via the one or more keyword engines, the input sound-data stream representing the sound detected by the one or more microphones for a wake word associated with a cloud-based voice assistant service implemented via one or more servers that are remote from the NMD concurrently with monitoring the input sound-data stream for the one or more keywords associated with the local voice assistant, wherein detections of sound data matching the wake word trigger generation of wake-word detection events that cause processing via the cloud-based voice assistant service;
generating a wake-word detection event corresponding to a third voice input when the one or more keyword engines detect third sound data matching the wake word in the input sound-data stream; and
based generating the wake-word detection event, causing, via the network interface, the cloud-based voice assistant service to process the third voice input.

14. The method of claim 13, wherein forgoing processing of the second voice input via the local voice assistant comprises:
causing, via the network interface, the cloud-based voice assistant service to process the second voice input.

15. The method of claim 12, wherein forgoing processing of the second voice input via the local voice assistant comprises:
forgoing processing of the second voice input via either the local voice assistant or a cloud-based voice assistant.

16. The method of claim 12, further comprising:
monitor, via a speaker detection engine, the input sound-data stream for voice data that match the one or more predetermined speaker profiles, wherein determining that the first voice input matches the particular predetermined speaker profile comprises:
determining, via the speaker detection engine, that a portion of the input sound-data stream corresponding to the first voice input includes particular voice data matching the particular predetermined speaker profile such that the particular speaker of the first voice input is recognized.

17. The method of claim 12, further comprising:
detecting, via a neural network, presence of sound data representing the one or more keywords corresponding to the particular playback command in the first voice input, wherein the one or more keywords comprise the at least one first keyword.

18. The method of claim 12, wherein determining that the first voice input matches the particular predetermined speaker profile comprises:
detecting, via a neural network, presence of sound data matching the particular predetermined speaker profile such that the particular speaker of the first voice input is recognized.

19. At least one non-transitory computer-readable medium comprising program instructions that are executable by at least one processor such that a NMD is configured to:
monitor, via one or more keyword engines, an input sound-data stream representing sound detected by one or more microphones of the NMD for one or more keywords associated with a local voice assistant implemented on the NMD, wherein detections of sound data matching the one or more keywords trigger generation of wake-word detection events that cause processing via the local voice assistant;
generate a first keyword detection event corresponding to a first voice input when the one or more keyword engines detect first sound data matching at least one first keyword of the one or more keywords;
determine that the first voice input matches a particular predetermined speaker profile of one or more predetermined speaker profiles such that a particular speaker of the first voice input is recognized;
based on (i) generation of the first keyword detection event and (ii) the determination that the first voice input includes sound data matching the particular predetermined speaker profile, process the first voice input via the local voice assistant, wherein the program instructions that are executable by the at least one processor such that the NMD is configured to process the first voice input via the local voice assistant comprise program instructions that are executable by the at least one processor such that the NMD is configured to determine a particular playback command associated with the at least one first keyword;
cause at least one playback device to perform the particular playback command associated with the at least one first keyword;
generate a second keyword detection event corresponding to a second voice input when the one or more keyword engines detect second sound data matching at least one second keyword of the one or more keywords;
determine that the second voice input does not match any of the one or more predetermined speaker profiles such that a speaker for the second voice input cannot be recognized; and
based on (i) generation of the second keyword detection event and (ii) the determination that the second voice input does not match any of the one or more predetermined speaker profiles, forgo processing of the second voice input via the local voice assistant.

20. The at least one non-transitory computer-readable medium of claim 19, wherein the program instructions that are executable by the at least one processor such that the NMD is configured to forgo processing of the second voice input via the local voice assistant comprise program instructions that are executable by the at least one processor such that the NMD is configured to:
forgo processing of the second voice input via either the local voice assistant or a cloud-based voice assistant.
